(19) United States
(12) Patent Application Publication
(10) Pub. No.: US 2008/0254168 A1
(43) Pub. Date: Oct. 16, 2008

(54) Dried Food Compositions

(75) Inventors: Izumi Mueller, Glen Carbon, MO (US); Marcus N. Hamilton, Idaho Falls, ID (US)

Correspondence Address: Solae, LLC, 4300 Duncan Avenue, Legal Department E4, St. Louis, MO, 63110, US

(73) Assignee: SOLAE, LLC, St. Louis, MO (US)

(21) Appl. No.: 12/062,366

(22) Filed: Apr. 3, 2008

Related U.S. Application Data
(60) Provisional application No. 60/910,952, filed on Apr. 10, 2007.

(51) Int. Cl. A23J 3/14; A23L 1/31; A23L 1/315; A23L 1/325; A23L 1/33; A23C 13/00; A23C 15/00; A23C 19/00; A23D 7/00; A23L 1/27; A23L 1/302; A23L 1/22; C11B 5/00; A23L 1/00

(52) U.S. Cl. 426/72; 426/656; 426/643; 426/644; 426/641; 426/581; 426/582; 426/586; 426/601; 426/608; 426/540; 426/651; 426/650; 426/545; 426/546; 426/544; 426/654

(57) ABSTRACT

The invention provides dried food compositions. In particular, the dried food compositions generally contain a structured protein along with other macronutrients and micronutrients.

### CROSS REFERENCE TO RELATED APPLICATIONS

This application claims priority from U.S. Provisional Application Ser. No. 60/910,952 filed on Apr. 10, 2007, which is hereby incorporated by reference in its entirety.

### FIELD OF THE INVENTION

The present invention generally provides dried food compositions, such as dehydrated and intermediate moisture food compositions. In particular, the dried food compositions generally comprise a structured protein product along with other macronutrients, micronutrients, and optional ingredients.

### BACKGROUND OF THE INVENTION

Drying is the world's oldest and most common method of food preservation. Canning technology is less than 200 years old and freezing became practical only when electricity became readily available. Drying technology is both simple and readily available to most of the world's culture.

The scientific principal of preserving food by drying is that by removing moisture, enzymes cannot efficiently contact or react with the food. Whether these enzymes are bacterial, fungal, or naturally occurring autolytic enzymes from the raw food, preventing this enzymatic action preserves the food from biological action. Additionally, intermediate moisture food is also shelf stable. It is made by partially removing water and reducing water activity to the range of about 0.5 to about 0.95, in which water becomes immobilized and biological activities are inhibited. At the water activity range from 0.70 to 0.95, a proper package and or oxygen scavenger may be required to remove oxygen, thereby inhibiting molds and pathogens.

Jerky is a nutrient-dense meat product that has been made lightweight by drying. Primarily due to its high protein and low fat content, many attempts have been made to utilize soy in the manufacture of edible products which resemble those made from real meat. However, difficulties in mimicking the flavor and texture of meat have been prohibitive.

Attempts at making a vegetable-based or vegetable containing jerky style meat snacks have thus far met with poor results. In addition to overcoming flavor and texture difficulties, problems in extrusion of the vegetable mixture are well known. One such extrusion difficulty has been the vegetable material flowing faster through the middle of the die leading to puffing in the center of the extrudate.

### SUMMARY OF THE INVENTION

One aspect of the invention provides a dried food composition. The dried food composition generally comprises a structured protein product having protein fibers that are substantially aligned. The composition also generally comprises a firming agent.

Another aspect of the invention provides a dried food composition. The dried food composition generally comprises a structured protein product having from about 45% to about 65% soy protein-on a dry matter basis; from about 20% to about 30% wheat gluten on a dry matter basis; from about 10% to about 15% wheat starch on a dry matter basis; and from about 1% to about 5% fiber on a dry matter basis. The composition also generally comprises a firming agent.

Other aspects and iterations of the invention are described in more detail herein.

### REFERENCE TO COLOR FIGURES

The application contains at least one photograph executed in color. Copies of this patent application publication with color photographs will be provided by the Office upon request and payment of the necessary fee.

### FIGURE LEGENDS

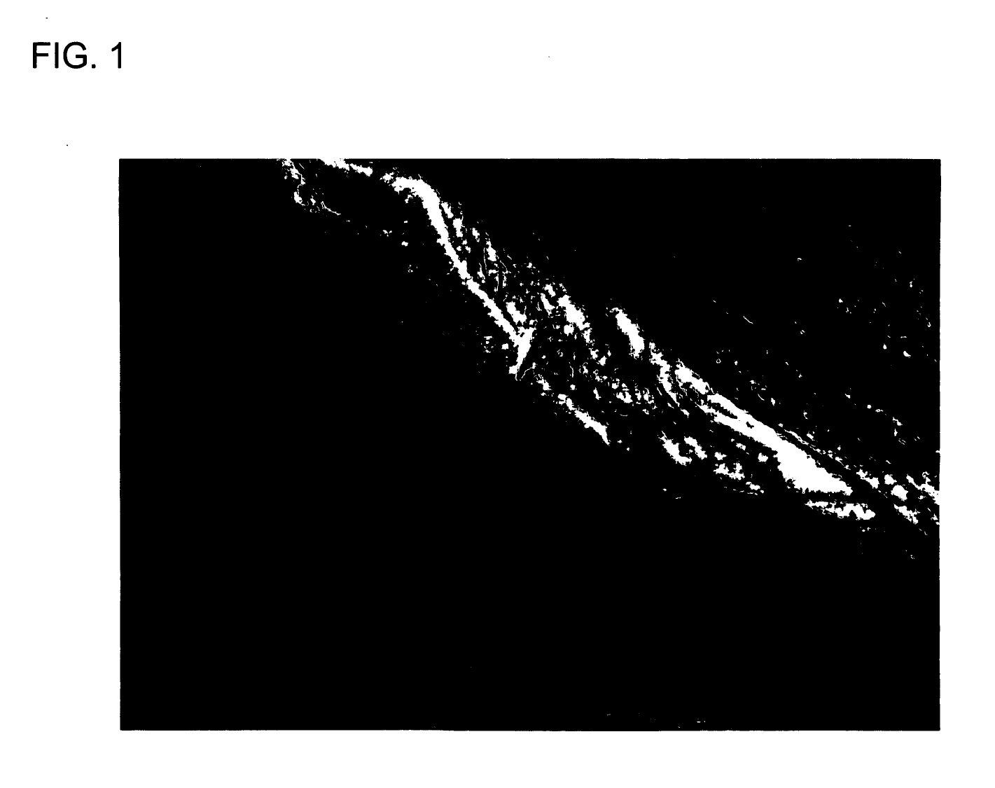

FIG. 1 depicts a photographic image of a micrograph showing a structured protein product of the invention having protein fibers that are substantially aligned.

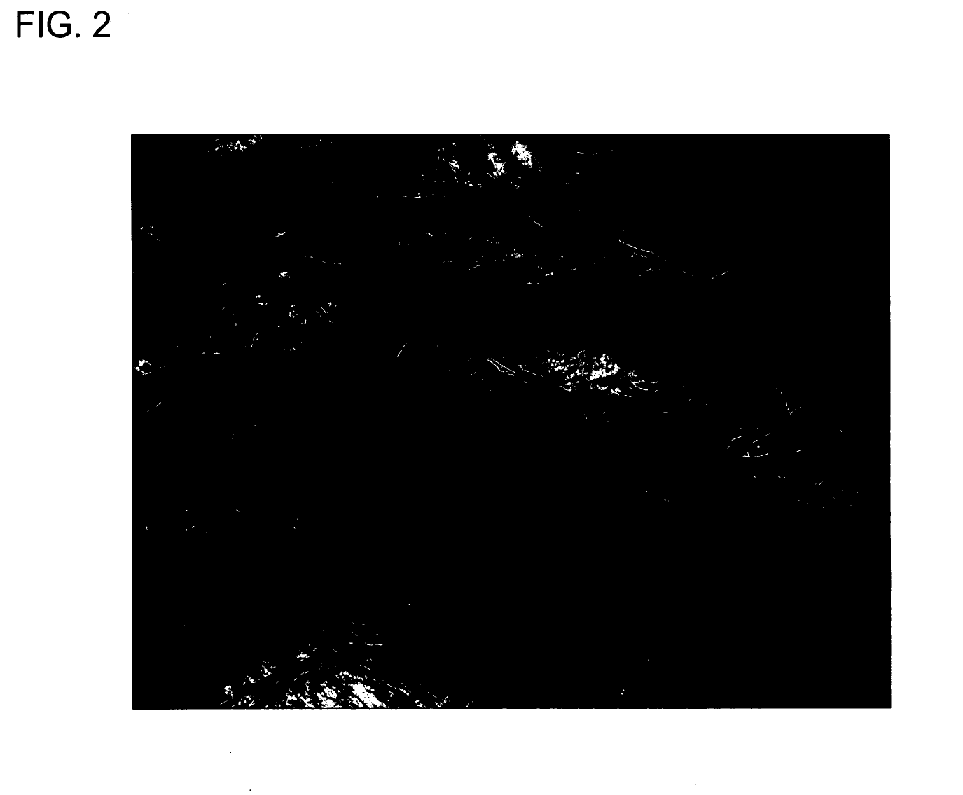

FIG. 2 depicts a photographic image of a micrograph showing a protein product not produced by the process of the present invention. The protein fibers comprising the plant protein product, as described herein, are crosshatched.

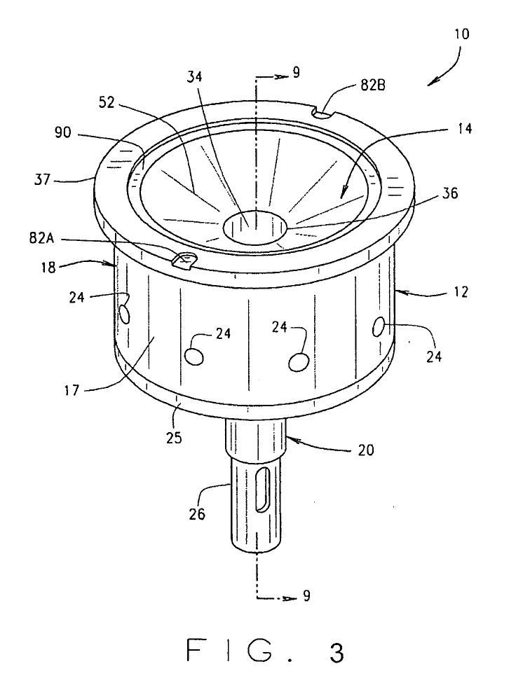

FIG. 3 depicts a perspective view of one embodiment of the peripheral die assembly that may be used in the extrusion process of the protein containing materials.

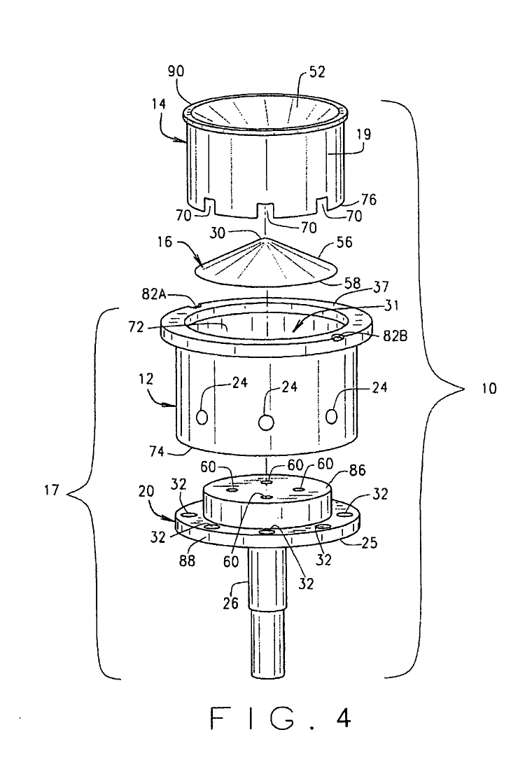

FIG. 4 depicts an exploded view of the peripheral die assembly showing the die insert, die sleeve, and die cone.

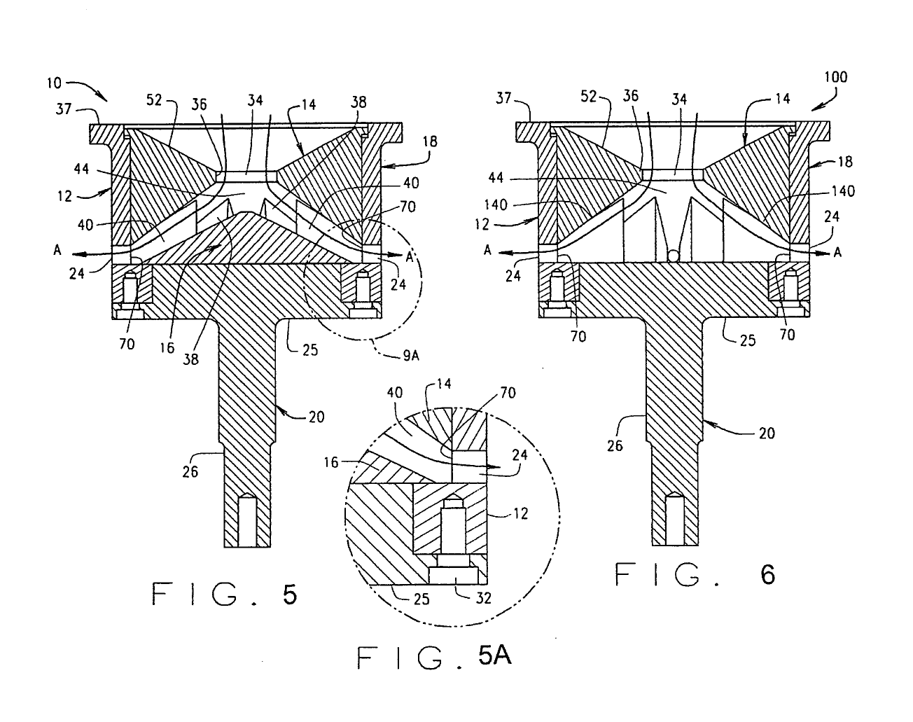

FIG. 5 depicts a cross-sectional view taken showing a flow channel defined between the die sleeve, die insert, and die cone arrangement.

FIG. 5A depicts an enlarged cross-sectional view of FIG. 5 showing the interface between the flow channel and the outlet of the die sleeve.

FIG. 6 depicts a cross-sectional view of an embodiment of the peripheral die assembly without the die cone.

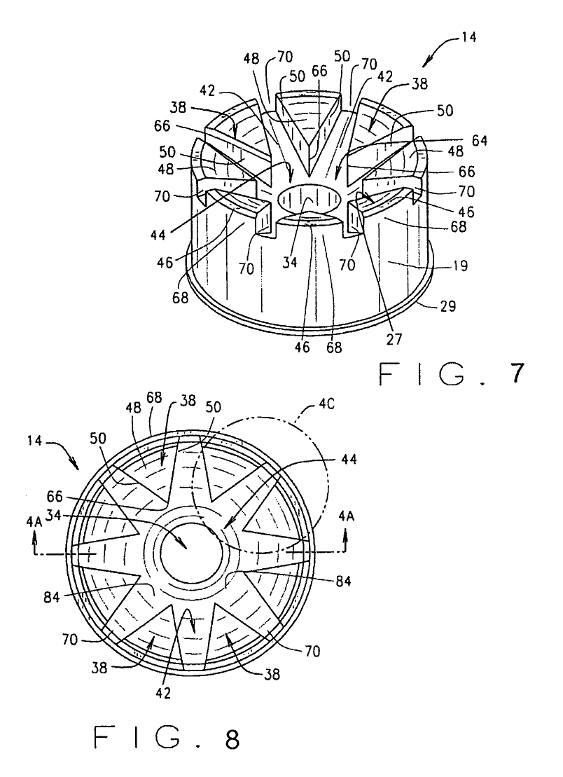

FIG. 7 depicts a perspective view of the die insert.

FIG. 8 depicts a top view of the die insert.

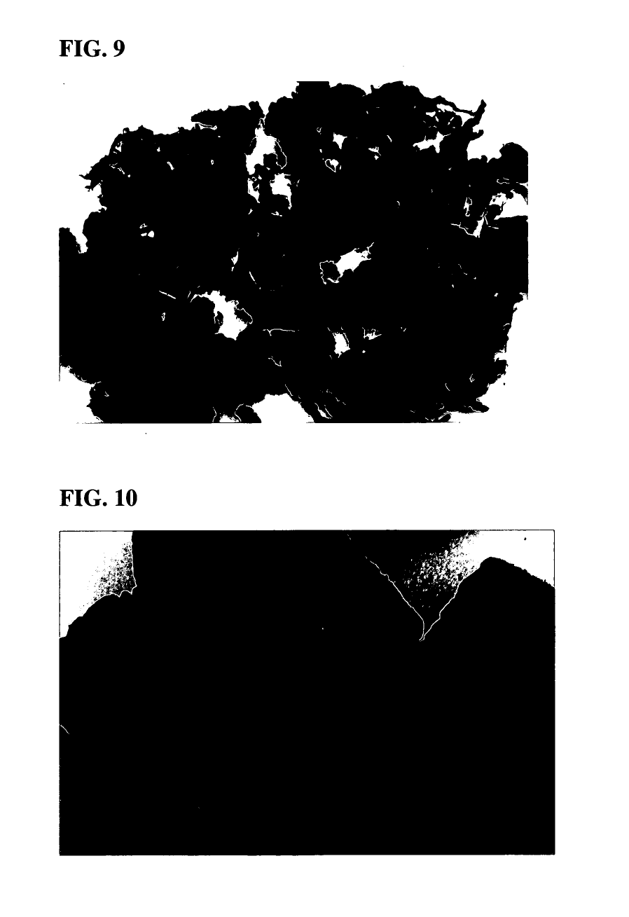

FIG. 9 depicts a photographic image of a shredded meat product comprised of the structured protein product of the present invention that can be used as a topping or a snack.

FIG. 10 depicts a photographic image of a snack bite product comprised of the structured protein product of the present invention.

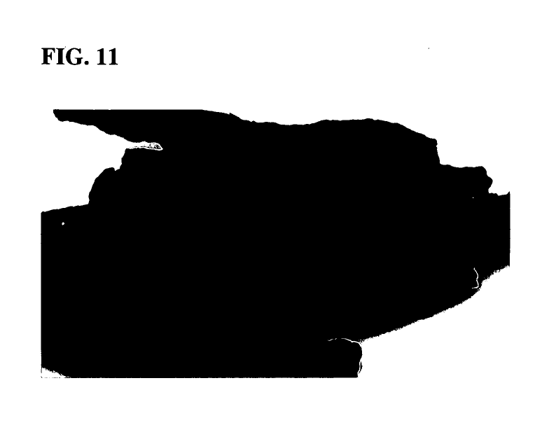

FIG. 11 depicts a photographic image of teriyaki strips that make up a meat snack comprised of the structured protein product of the present invention.

### DETAILED DESCRIPTION OF THE INVENTION

The present invention provides dried food compositions comprising macronutrients and micronutrients. The macronutrients and micronutrients may be produced organically or by conventional, non-organic means. Typically, the dried food composition is a blend of carbohydrates, proteins, fats, fiber, and a firming agent. As one nutrient source, the dried food composition will comprise a structured protein product.

### (I) Macronutrients

Macronutrients suitable for use in the dried food compositions of the invention include protein, fat, fiber, carbohydrate, and combinations thereof. Suitable sources of each of these ingredients are detailed below. Organic food compositions are envisioned. Generally speaking, all of the macronutrient sources detailed below are suitable for use in organic food compositions to the extent the ingredients have been produced in accordance with organic food production techniques generally known in the art, and as the term “organic” is defined herein.

### 1. Protein

Several sources of protein are suitable for use in the invention. The protein may be derived from an animal source. Alternatively, the protein may be derived from a plant source. In an exemplary embodiment, the protein will comprise a structured plant protein as detailed below. Vegetarian dried food compositions are envisioned. For vegetarian dried food compositions, the protein source will typically be comprised of 100% plant protein. In other embodiments, the non-vegan vegetarian food compositions may include dairy protein or egg protein. Irrespective of its source or ingredient classification, the ingredients utilized in the extrusion process are typically capable of forming structured protein products having protein fibers that are substantially aligned. Suitable examples of such ingredients are detailed more fully below.

The dried food compositions may have a protein content that varies widely. Typically, the dried food compositions have a protein content from about 1% to about 99% by weight of the composition. More typically, the amount may be from about 1% to about 70% by weight of the composition and even more typically from about 10% to about 50%. For example, the amount of protein may be from about 1% to about 5%, from about 5% to about 10%, from about 10% to about 15%, from about 15% to about 20%, from about 20% to about 25%, from about 25% to about 30%, from about 30% to about 35%, from about 35% to about 40%, from about 40% to about 45%, from about 45% to about 50%, or greater than 50% by weight of the composition.

A. Structured Plant Protein Product

The dried food compositions comprise structured plant protein products as a part of the protein source. A variety of ingredients that contain protein may be utilized in a thermal plastic extrusion process to produce structured protein products suitable for use in the dried food compositions. While ingredients comprising proteins derived from plants are typically used, it is also envisioned that proteins derived from other sources, such as animal sources, may be utilized without departing from the scope of the invention. For example, a dairy protein selected from the group consisting of casein, caseinates, whey protein, and mixtures thereof may be utilized. In an exemplary embodiment, the dairy protein is whey protein. By way of further example, an egg protein selected from the group consisting of ovalbumin, ovoglobulin, ovomucin, ovomucoid, ovotransferrin, ovovitella, ovovitellin, albumin globulin, vitellin, and combinations thereof may be utilized. Further, meat proteins or protein ingredients consisting of collagen, blood, organ meat, mechanically separated meat, partially defatted tissue, blood serum proteins, and combinations thereof may be included as one or more of the ingredients of the structured protein products.

It is envisioned that other ingredient types in addition to proteins may be utilized. Non-limiting examples of such ingredients include sugars, starches, oligosaccharides, soy fiber, other dietary fibers, and combinations thereof.

While in some embodiments gluten may be used as a protein, it is also envisioned that the protein-containing starting materials may be gluten-free. Further, it is envisioned that the protein-containing starting materials may be wheat-free. Because gluten is typically used in filament formation during the extrusion process, if a gluten-free starting material is used, an edible cross-linking agent may be utilized to facilitate filament formation. Non-limiting examples of suitable cross-linking agents include Konjac glucomannan (KGM) flour, beta 1, 3 glucan from Curdlan by Kirin Food-Tech (Japan), transglutaminase, calcium salts, magnesium salts, and combinations thereof. One skilled in the art can readily determine the amount of cross-linking material needed, if any, in gluten-free embodiments.

Irrespective of its source or ingredient classification, the ingredients utilized in the extrusion process are typically capable of forming extrudates having protein fibers that are substantially aligned. Suitable examples of such ingredients are detailed more fully below.

(a) Protein Containing Material

i. Animal Meat

A variety of animal meats are suitable as a protein source. Animals from which the meat is obtained may be raised conventionally or organically. By way of example, meat and meat ingredients defined specifically for the various structured vegetable protein patents include intact or ground beef, pork, lamb, mutton, horsemeat, goat meat, meat, fat and skin of poultry (domestic fowl such as chicken, duck, goose or turkey) and more specifically flesh tissues from any fowl (any bird species), fish flesh derived from both fresh and salt water, animal flesh of shellfish and crustacean origin, animal flesh trim and animal tissues derived from processing such as frozen residue from sawing frozen fish, chicken, beef, pork etc., chicken skin, pork skin, fish skin, animal fats such as beef fat, pork fat, lamb fat, chicken fat, turkey fat, rendered animal fat such as lard and tallow, flavor enhanced animal fats, fractionated or further processed animal fat tissue, finely textured beef, finely textured pork, finely textured lamb, finely textured chicken, low temperature rendered animal tissues such as low temperature rendered beef and low temperature rendered pork, mechanically separated meat or mechanically deboned meat (MDM) (meat flesh removed from bone by various mechanical means) such as mechanically separated beef, mechanically separated pork, mechanically separated fish including surimi, mechanically separated chicken, mechanically separated turkey, any cooked animal flesh, organ meats derived from any animal species, and combinations thereof. Meat flesh should be extended to include muscle protein fractions derived from salt fractionation of the animal tissues, protein ingredients derived from isoelectric fractionation and precipitation of animal muscle or meat and hot boned meat as well as mechanically prepared collagen tissues and gelatin. Additionally, meat, fat, connective tissue and organ meats of game animals such as buffalo, deer, elk, moose, reindeer, caribou, antelope, rabbit, bear, squirrel, beaver, muskrat, opossum, raccoon, armadillo, and porcupine as well as reptilian creatures such as snakes, turtles, lizards, and combinations thereof should be considered meat.

In a further embodiment, the animal meat may be from fish or seafood. Non-limiting examples of suitable fish include bass, carp, catfish, cobia, cod, grouper, flounder, haddock, hoki, perch, pollock, salmon, snapper, sole, trout, tuna, whitefish, whiting, tilapia, and combinations thereof. Non-limiting examples of seafood include scallops, shrimp, lobster, clams, crabs, mussels, oysters, and combinations thereof.

It is also envisioned that a variety of meat qualities may be utilized in the invention. The meat may comprise muscle tissue, organ tissue, connective tissue, skin, and combinations thereof. The meat may be any meat suitable for human consumption. The meat may be non-rendered, non-dried, raw meat, raw meat products, raw meat by-products, and mixtures thereof. For example, whole meat muscle that is either ground or in chunk or steak form may be utilized. In another embodiment, the meat may be mechanically deboned or separated raw meats using high-pressure machinery that separates bone from animal tissue, by first crushing bone and adhering animal tissue and then forcing the animal tissue, and not the bone, through a sieve or similar screening device. The process forms an unstructured, paste-like blend of soft animal tissue with a batter-like consistency and is commonly referred to as mechanically deboned meat or MDM. Alternatively, the meat may be a meat by-product. In the context of the present invention, the term “meat by-products” is intended to refer to those non-rendered parts of the carcass of slaughtered animals including but not restricted to mammals, poultry, and the like. Examples of meat by-products are organs and tissues such as lungs, spleens, kidneys, brain, liver, blood, bone, partially defatted low-temperature fatty tissues, stomachs, intestines free of their contents, and the like.

(ii) Non-Meat Animal Derived Protein

The protein source may also be an animal derived protein other than animal tissue. For example, the protein-containing material may be derived from a dairy product. Suitable dairy protein products include non-fat dried milk powder, milk protein isolate, milk protein concentrate, liquid milk, casein protein isolate, casein protein concentrate, caseinates, whey proteins, whey protein isolate, whey protein concentrate, and combinations thereof. The milk protein-containing material may be derived from cows, goats, sheep, donkeys, camels, camelids, yaks, horse, or water buffalos. In an exemplary embodiment, the dairy protein is whey protein.

By way of further example, a protein-containing material may also be from an egg product. Suitable egg protein products include powdered egg, dried egg solids, dried egg white protein, liquid egg white protein, egg white protein powder, isolated ovalbumin protein, and combinations thereof. Examples of suitable isolated egg proteins include ovalbumin, ovoglobulin, ovomucin, ovomucoid, ovotransferrin, ovovitella, ovovitellin, albumin globulin, vitellin, and combinations thereof. Egg protein products may be derived from the eggs of chicken, duck, goose, quail, or other birds.

(iii) Plant Derived Protein

In an exemplary embodiment, at least one ingredient derived from a plant will be utilized to form the structured protein product. Generally speaking, the ingredient will comprise a protein. The protein containing material derived from a plant may be a plant extract, a plant meal, a plant-derived flour, a plant protein isolate, a plant protein concentrate, and combinations thereof.

The ingredient(s) utilized in extrusion may be derived from a variety of suitable plants. The plants may be grown conventionally or organically. By way of non-limiting examples, suitable plants include amaranth, arrowroot, barley, buckwheat, cassaya, canola, channa (garbanzo), corn, kamut, lentil, lupin, millet, oat, pea, peanut, potato, quinoa, rice, rye, sorghum, sunflower, tapioca, triticale, wheat, or a mixture thereof. Exemplary plants include soy, wheat, canola, corn, lupin, oat, pea, potato, and rice.

In one embodiment, the ingredients may be isolated from wheat and soybeans. In another exemplary embodiment, the ingredients may be isolated from soybeans. In a further embodiment, the ingredients may be isolated from wheat. Suitable wheat derived protein-containing ingredients include wheat gluten, wheat flour, and mixtures thereof. Examples of commercially available wheat gluten that may be utilized in the invention include Manildra Gem of the West Vital Wheat Gluten and Manildra Gem of the West Organic Vital Wheat Gluten each of which is available from Manildra Milling. Suitable soy derived protein-containing ingredients (“soy protein material”) include soy protein isolate, soy protein concentrate, soy flour, and mixtures thereof, each of which is detailed below.

In an exemplary embodiment, as detailed above, soy protein isolate, soy protein concentrate, soy flour, and mixtures thereof may be utilized in the extrusion process. The soy protein materials may be derived from whole soybeans in accordance with methods generally known in the art. The whole soybeans may be standard soybeans (i.e., non genetically modified soybeans), organic soybeans, commoditized soybeans, genetically modified soybeans, and combinations thereof.

In one embodiment, the soy protein material may be a soy protein isolate (SPI). In general, a soy protein isolate has a protein content of at least about 90% soy protein on a moisture-free basis. Generally speaking, when soy protein isolate is used, an isolate is preferably selected that is not a highly hydrolyzed soy protein isolate. In certain embodiments, highly hydrolyzed soy protein isolates, however, may be used in combination with other soy protein isolates provided that the highly hydrolyzed soy protein isolate content of the combined soy protein isolates is generally less than about 40% of the combined soy protein isolates, by weight. Additionally, the soy protein isolate utilized preferably has an emulsion strength and gel strength sufficient to enable the protein in the isolate to form fibers that are substantially aligned upon extrusion. Examples of soy protein isolates that are useful in the present invention are commercially available, for example, from Solae, LLC (St. Louis, Mo.), and include SUPRO® 500E, SUPRO® EX 33, SUPRO® 620, SUPRO® EX45, SUPRO® 595, and combinations thereof. In an exemplary embodiment, a form of SUPRO® 620 is utilized as detailed in Example 3.

Alternatively, soy protein concentrate may be blended with the soy protein isolate to substitute for a portion of the soy protein isolate as a source of soy protein material. Typically, if a soy protein concentrate is substituted for a portion of the soy protein isolate, the soy protein concentrate is substituted for up to about 55% of the soy protein isolate by weight. The soy protein concentrate can be substituted for up to about 50% of the soy protein isolate by weight. It is also possible in an embodiment to substitute 40% by weight of the soy protein concentrate for the soy protein isolate. In another embodiment, the amount of soy protein concentrate substituted is up to about 30% of the soy protein isolate by weight. Examples of suitable soy protein concentrates useful in the invention include PROCON™, ALPHA™ 12, ALPHA™ 5800, and combinations thereof, which are commercially available from Solae, LLC (St. Louis, Mo.).

In yet another embodiment, the soy protein material may be soy flour, which has a protein content of about 49% to about 65% on a moisture-free basis. If soy flour is substituted for a portion of the soy protein isolate, the soy flour is substituted for up to about 35% of the soy protein isolate by weight. The soy flour should be a high protein dispersibility index (PDI) soy flour. When soy flour is used, the starting material is preferably a defatted soybean flour or flakes. Full fat soybeans contain approximately 40% protein by weight and approximately 20% oil by weight. These whole full fat soybeans may be defatted through conventional processes when a defatted soy flour or flakes form the starting protein material. For example, the bean may be cleaned, dehulled, cracked, passed through a series of flaking rolls and then subjected to solvent extraction by use of hexane or other appropriate solvents to extract the oil and produce “spent flakes”. The defatted flakes may be ground to produce a soy flour. Although the process is yet to be employed with full fat soy flour, it is believed that full fat soy flour may also serve as a protein source. However, where full fat soy flour is processed, it is most likely necessary to use a separation step, such as three-stage centrifugation to remove oil. Alternatively, soy flour may be blended with soy protein isolate or soy protein concentrate.

(iv) Combination of Protein Containing Material

Non-limiting combinations of protein-containing materials isolated from a variety of sources are detailed in Table A. In one embodiment, the protein-containing material is derived from soybeans. In a preferred embodiment, the protein-containing material comprises a mixture of materials derived from soybeans and wheat. In another preferred embodiment, the protein-containing material comprises a mixture of materials derived from soybeans and canola. In still another preferred embodiment, the protein-containing material comprises a mixture of materials derived from soybeans, wheat, and dairy, wherein the dairy protein is whey.

TABLE A
Combinations of Protein-Containing Materials.

| First protein ingredient | Second protein ingredient |
|---|---|
| Soybean | wheat |
| Soybean | canola |
| Soybean | corn |
| Soybean | lupin |
| Soybean | oat |
| Soybean | pea |
| Soybean | rice |
| Soybean | sorghum |
| Soybean | amaranth |
| Soybean | arrowroot |
| soybean | barley |
| soybean | buckwheat |
| soybean | cassava |
| soybean | channa (garbanzo) |
| soybean | millet |
| soybean | peanut |
| soybean | potato |
| soybean | rye |
| soybean | sunflower |
| soybean | tapioca |
| soybean | triticale |
| soybean | dairy |
| soybean | whey |
| soybean | egg |
| soybean | wheat and canola |
| soybean | wheat and corn |
| soybean | wheat and lupin |
| soybean | wheat and oat |
| soybean | wheat and pea |
| soybean | wheat and rice |
| soybean | wheat and sorghum |
| soybean | wheat and amaranth |
| soybean | wheat and arrowroot |
| soybean | wheat and barley |
| soybean | wheat and buckwheat |
| soybean | wheat and cassava |
| soybean | wheat and channa (garbanzo) |
| soybean | wheat and millet |
| soybean | wheat and peanut |
| soybean | wheat and rye |
| soybean | wheat and potato |
| soybean | wheat and sunflower |
| soybean | wheat and tapioca |
| soybean | wheat and triticale |
| soybean | wheat and dairy |
| soybean | wheat and whey |
| soybean | wheat and egg |
| soybean | canola and corn |
| soybean | canola and lupin |
| soybean | canola and oat |
| soybean | canola and pea |
| soybean | canola and rice |
| soybean | canola and sorghum |
| soybean | canola and amaranth |
| soybean | canola and arrowroot |
| soybean | canola and barley |
| soybean | canola and buckwheat |
| soybean | canola and cassava |
| soybean | canola and channa (garbanzo) |
| soybean | canola and millet |
| soybean | canola and peanut |
| soybean | canola and rye |
| soybean | canola and potato |
| soybean | canola and sunflower |
| soybean | canola and tapioca |
| soybean | canola and triticale |
| soybean | canola and dairy |
| soybean | canola and whey |
| soybean | canola and egg |
| soybean | corn and lupin |
| soybean | corn and oat |
| soybean | corn and pea |
| soybean | corn and rice |
| soybean | corn and sorghum |
| soybean | corn and amaranth |
| soybean | corn and arrowroot |
| soybean | corn and barley |
| soybean | corn and buckwheat |
| soybean | corn and cassava |
| soybean | corn and channa (garbanzo) |
| soybean | corn and millet |
| soybean | corn and peanut |
| soybean | corn and rye |
| soybean | corn and potato |
| soybean | corn and sunflower |
| soybean | corn and tapioca |
| soybean | corn and triticale |
| soybean | corn and dairy |
| soybean | corn and whey |
| soybean | corn and egg |

In each of the embodiments delineated in Table A, the combination of protein-containing materials may be combined with one or more ingredients selected from the group consisting of a starch, flour, gluten, a dietary fiber, and mixtures thereof. In one embodiment, the protein-containing material comprises protein, starch, gluten, and fiber. In an exemplary embodiment, the protein-containing material comprises from about 45% to about 65% soy protein on a dry matter basis; from about 20% to about 30% wheat gluten on a dry matter basis; from about 10% to about 15% wheat starch on a dry matter basis; and from about 1% to about 5% fiber on a dry matter basis. In each of the foregoing embodiments, the protein-containing material may comprise dicalcium phosphate, L-cysteine and combinations of dicalcium phosphate and L-cysteine.

(b) Additional Ingredients

(i) Carbohydrates

It is envisioned that other ingredient additives in addition to proteins may be utilized in the structured protein products. Non-limiting examples of such ingredients include sugars, starches, oligosaccharides, and dietary fibers. As an example, starches may be derived from wheat, corn, tapioca, potato, rice, and the like. A suitable fiber source may be soy cotyledon fiber. Typically, suitable soy cotyledon fiber will generally effectively bind water when the mixture of soy protein and soy cotyledon fiber is co-extruded. In this context, “effectively bind water” generally means that the soy cotyledon fiber has a water holding capacity of at least 5.0 to about 8.0 grams of water per gram of soy cotyledon fiber, and preferably the soy cotyledon fiber has a water holding capacity of at least about 6.0 to about 8.0 grams of water per gram of soy cotyledon fiber. Soy cotyledon fiber may generally be present in the soy protein-containing material in an amount ranging from about 1% to about 20% by weight on a moisture free basis, preferably from about 1.5% to about 20% by weight on a moisture free basis, and most preferably, at from about 2% to about 5% by weight on a moisture free basis. Suitable soy cotyledon fiber is commercially available. For example, FIBRIM® 1260 and FIBRIM® 2000 are soy cotyledon fiber materials that are commercially available from Solae, LLC (St. Louis, Mo.).

(ii) pH Adjusting Agent

In some embodiments, it may be desirable to lower the pH of the protein-containing material to an acidic pH (i.e., below approximately 7.0). Thus, the protein-containing material may be contacted with a pH-lowering agent, and the mixture is then extruded according to the process detailed below. In one embodiment, the pH of the protein-containing material to be extruded may range from about 6.0 to about 7.0. In another embodiment, the pH may range from about 5.0 to about 6.0. In an alternate embodiment, the pH may range from about 4.0 to about 5.0. In yet another embodiment, the pH of the material may be less than about 4.0.

Several pH-lowering agents are suitable for use in the invention. The pH-lowering agent may be organic. Alternatively, the pH-lowering agent may be inorganic. In exemplary embodiments, the pH-lowering agent is a food grade edible acid. Non-limiting acids suitable for use in the invention include acetic, lactic, hydrochloric, phosphoric, citric, tartaric, malic, and combinations thereof. In an exemplary embodiment, the pH-lowering agent is lactic acid.

As will be appreciated by a skilled artisan, the amount of pH-lowering agent contacted with the protein-containing material can and will vary depending upon several parameters, including, the agent selected and the desired pH. In one embodiment, the amount of pH-lowering agent may range from about 0.1% to about 15% on a dry matter basis. In another embodiment, the amount of pH-lowering agent may range from about 0.5% to about 10% on a dry matter basis. In an alternate embodiment, the amount of pH-lowering agent may range from about 1% to about 5% on a dry matter basis. In still another embodiment, the amount of pH-lowering agent may range from about 2% to about 3% on a dry matter basis.

In some embodiments, it may be desirable to raise the pH of the protein-containing material. Thus, the protein-containing material may be contacted with a pH-raising agent, and the mixture is then extruded according to the process detailed below.

(iii) Antioxidents

One or more antioxidants may be added to any of the combinations of protein-containing materials mentioned above without departing from the scope of the invention. Antioxidants may be included to increase the shelf-life or nutritionally enhance the structured protein products. Non-limiting examples of suitable antioxidants include BHA, BHT, TBHQ, vitamin A, vitamin C, and vitamin E, derivatives of these vitamins, and various plant extracts, such as those containing carotenoids, tocopherols or flavonoids having antioxidant properties, and combinations thereof. The antioxidants may have a combined presence at levels of from about 0.01% to about 10%, preferably, from about 0.05% to about 5%, and more preferably from about 0.1% to about 2%, by weight of the protein-containing materials that will be extruded.

(iv) Minerals and Amino Acids

The protein-containing material may also optionally comprise supplemental minerals. Suitable minerals may include one or more minerals or mineral sources. Non-limiting examples of minerals include, without limitation, chloride, sodium, calcium, iron, chromium, copper, iodine, zinc, magnesium, manganese, molybdenum, phosphorus, potassium, selenium, and combinations thereof. Suitable forms of any of the foregoing minerals include soluble mineral salts, slightly soluble mineral salts, insoluble mineral salts, chelated minerals, mineral complexes, non-reactive minerals such as carbonate minerals, reduced minerals, and combinations thereof.

Free amino acids may also be included in the protein-containing material. Suitable amino acids include the essential amino acids, i.e., arginine, cysteine, histidine, isoleucine, leucine, lysine, methionine, phenylalanine, threonine, tryptophan, tyrosine, valine, and combinations thereof. Suitable forms of the amino acids include salts and chelates.

(v) Colorants

The structured protein product may comprise one or more colorants. The colorant is mixed with the protein containing material and other ingredients prior to being fed into the extruder or the colorant is mixed with the protein containing material and other ingredients while in the extruder or during the extrusion process. Exemplary colorants that can be used are any colorant currently used in the food industry. Further examples are provide below.

(c) Process for Producing the Dried Structured Protein Product

The dried structured protein products of the invention are made by extruding protein-containing material through a die assembly under conditions of elevated temperature and pressure. Typically, the protein-containing material may be combined with other macronutrients, micronutrients, and optional ingredients. After extrusion, the resulting dried structured protein product comprises protein fibers that are substantially aligned.

(i) Moisture Content

As will be appreciated by the skilled artisan, the moisture content of the protein-containing materials can and will vary depending upon the extrusion process. Generally speaking, the moisture content may range from about 1% to about 80% by weight. In low moisture extrusion applications, the moisture content of the protein-containing materials may range from about 1% to about 35% by weight. Alternatively, in high moisture extrusion applications, the moisture content of the protein-containing materials may range from about 35% to about 80% by weight. In an exemplary embodiment, the extrusion application utilized to form the extrudates is low moisture. An exemplary example of a low moisture extrusion process to produce structured protein products having protein fibers that are substantially aligned is detailed below and in Example 3.

(ii) Extrusion

A suitable extrusion process for the preparation of a structured protein product comprises introducing the protein-containing material and other ingredients into a mixing tank (i.e., an ingredient blender) to combine the ingredients and form a blended protein material pre-mix. In one embodiment, the blended protein material pre-mix may be combined with at least one colorant. The blended protein material pre-mix may then be transferred to a hopper from which the blended ingredients may be introduced along with moisture into the extruder. In another embodiment, the blended protein material pre-mix may be combined with a conditioner to form a conditioned protein material mixture. In an alternative embodiment, at least one colorant may be combined with the conditioner forming a colored conditioned protein material mixture. The conditioned material may then be fed into an extruder in which the protein material mixture is heated under mechanical pressure generated by the screws of the extruder to form a colored molten extrusion mass. In an exemplary embodiment, at least one colorant may be injected into the extruder barrel via one or more injection jets. The extrudate exits the extruder through an extrusion die and comprises protein fibers that are substantially aligned.

(iii) Extrusion Process Conditions

Among the suitable extrusion apparatuses useful in the practice of the present invention is a double barrel, twin-screw extruder as described, for example, in U.S. Pat. No. 4,600,311. Further examples of suitable commercially available extrusion apparatuses include a CLEXTRAL® Model BC-72 extruder manufactured by Clextral, Inc. (Tampa, Fla.); a WENGER Model TX-57 extruder, a WENGER Model TX-168 extruder, and a WENGER Model TX-52 extruder all manufactured by Wenger Manufacturing, Inc. (Sabetha, Kans.). Other conventional extruders suitable for use in this invention are described, for example, in U.S. Pat. Nos. 4,763,569, 4,118,164, and 3,117,006, which are hereby incorporated by reference in their entirety.

A single-screw extruder could also be used in the present invention. Examples of suitable, commercially available single-screw extrusion apparatuses include the WENGER Model X-175, the WENGER Model X-165, and the WENGER Model X-85, all of which are available from Wenger Manufacturing, Inc.

The screws of a twin-screw extruder can rotate within the barrel in the same or opposite directions. Rotation of the screws in the same direction is referred to as single flow whereas rotation of the screws in opposite directions is referred to as double flow or counter rotating. The speed of the screw or screws of the extruder may vary depending on the particular apparatus, however, it is typically from about 250 to about 450 revolutions per minute (rpm). Generally, as the screw speed increases, the density of the extrudate will decrease. The extrusion apparatus contains screws assembled from shafts and worm segments, as well as mixing lobe and ring-type shearlock elements as recommended by the extrusion apparatus manufacturer for extruding plant protein material.

The extrusion apparatus generally comprises a plurality of heating zones through which the protein mixture is conveyed under mechanical pressure prior to exiting the extrusion apparatus through an extrusion die. The temperature in each successive heating zone generally exceeds the temperature of the previous heating zone by between about 10° C. and about 70° C. In one embodiment, the conditioned pre-mix is transferred through four heating zones within the extrusion apparatus, with the protein mixture heated to a temperature of from about 100° C. to about 150° C. such that the molten extrusion mass enters the extrusion die at a temperature of from about 100° C. to about 150° C. One skilled in the art could adjust the temperature either heating or cooling to achieve the desired properties. Typically, temperature changes are due to work input and can happen suddenly.

The pressure within the extruder barrel is typically between about 50 psig to about 500 psig preferably between about 75 psig to about 200 psig. Generally, the pressure within the last two heating zones is from about 100 psig to about 3000 psig preferably between about 150 psig to about 500 psig. The barrel pressure is dependent on numerous factors including, for example, the extruder screw speed, feed rate of the mixture to the barrel, feed rate of water to the barrel, and the viscosity of the molten mass within the barrel.

Water may be injected into the extruder barrel to hydrate the protein material mixture and promote texturization of the proteins. As an aid in forming the molten extrusion mass, the water may act as a plasticizing agent. Water may be introduced to the extruder barrel via one or more injection jets in communication with a heating zone. In one embodiment, the water may be combined with at least one colorant and injected into the extruder barrel to color the protein material mixture. Typically, the mixture in the barrel contains from about 1% to about 35% by weight of water. In one embodiment, the mixture in the barrel contains from about 5% to about 20% by weight of water. The rate of introduction of water to any of the heating zones is generally controlled to promote production of an extrudate having desired characteristics. It has been observed that as the rate of introduction of water to the barrel decreases, the density of the extrudate decreases. Typically, less than about 1 kg of water per kg of protein is introduced to the barrel. Preferably, from about 0.1 kg to about 1 kg of water per kg of protein are introduced to the barrel.

(iv) Optional Preconditioning

In a pre-conditioner, the protein-containing material and optional additional ingredients (protein-containing mixture) are preheated, contacted with moisture, and held under controlled temperature and pressure conditions to allow the moisture to penetrate and soften the individual particles. In one embodiment, the protein-containing material and optional additional ingredients may be combined with at least one colorant. The preconditioning step increases the bulk density of the particulate fibrous material mixture and improves its flow characteristics. The preconditioner contains one or more paddles to promote uniform mixing of the protein and transfer of the protein mixture through the preconditioner. The configuration and rotational speed of the paddles vary widely, depending on the capacity of the preconditioner, the extruder throughput and/or the desired residence time of the mixture in the preconditioner or extruder barrel. Generally, the speed of the paddles is from about 100 to about 1300 revolutions per minute (rpm). Agitation must be high enough to obtain even hydration and good mixing.

Typically, the protein-containing mixture is pre-conditioned prior to introduction into the extrusion apparatus by contacting the pre-mix with moisture (i.e., steam and/or water). In one embodiment, the pre-mix is combined with moisture and at least one colorant. Preferably the protein-containing mixture is heated to a temperature of from about 25° C. to about 80° C., more preferably from about 30° C. to about 40° C. in the preconditioner.

Typically, the protein-containing pre-mix is conditioned for a period of about 0.5 minutes to about 10.0 minutes, depending on the speed and the size of the pre-conditioner. In an exemplary embodiment, the protein-containing pre-mix is conditioned for a period of about 3.0 minutes to about 5.0 minutes. In a further example, the period for conditioning is about 30 seconds to about 60 seconds. The pre-mix is contacted with steam and/or water and heated in the pre-conditioner at generally constant steam flow to achieve the desired temperatures. The water and/or steam conditions (i.e., hydrates) the pre-mix, increases its density, and facilitates the flowability of the dried mix without interference prior to introduction to the extruder barrel where the proteins are texturized. If low moisture pre-mix is desired, the conditioned pre-mix may contain from about 1% to about 35% (by weight) of water. If high moisture pre-mix is desired, the conditioned pre-mix may contain from about 35% to about 80% (by weight) water.

The conditioned pre-mix typically has a bulk density of from about 0.25 g/cm³ to about 0.60 g/cm³. Generally, as the bulk density of the pre-conditioned protein mixture increases within this range, the protein mixture is easier to process. This is presently believed to be due to such mixtures occupying all or a majority of the space between the screws of the extruder, thereby facilitating conveying the extrusion mass through the barrel.

(v) Extrusion Process

The dry pre-mix or the conditioned pre-mix is then fed into an extruder to heat, shear, and ultimately plasticize the mixture. The extruder may be selected from any commercially available extruder and may be a single screw extruder or preferably a twin-screw extruder that mechanically shears the mixture with the screw elements.

The rate at which the pre-mix is generally introduced to the extrusion apparatus will vary depending upon the particular apparatus. Generally, the pre-mix is introduced at a rate of no more than about 75 kilograms per minute. Generally, it has been observed that the density of the extrudate decreases as the feed rate of pre-mix to the extruder increases. Whatever extruder is used, it should be run in excess of about 50% motor load. The rate at which the pre-mix is generally introduced to the extrusion apparatus will vary depending upon the particular apparatus. Typically, the conditioned pre-mix is introduced to the extrusion apparatus at a rate of between about 16 kilograms per minute to about 60 kilograms per minute. In another embodiment, the conditioned pre-mix is introduced to the extrusion apparatus at a rate between 20 kilograms per minute to about 40 kilograms per minute. the conditioned pre-mix is introduced to the extrusion apparatus at a rate of between about 26 kilograms per minute to about 32 kilograms per minute. Generally, it has been observed that the density of the extrudate decreases as the feed rate of pre-mix to the extruder increases.

The pre-mix is subjected to shear and pressure by the extruder to plasticize the mixture. The screw elements of the extruder shear the mixture as well as create pressure in the extruder by forcing the mixture forwards though the extruder and through the die assembly. The screw motor speed determines the amount of shear and pressure applied to the mixture by the screw(s). Preferably, the screw motor speed is set to a speed of from about 200 rpm to about 500 rpm, and more preferably from about 300 rpm to about 450 rpm, which moves the mixture through the extruder at a rate of at least about 20 kilograms per minute, and more preferably at least about 40 kilograms per minute. Preferably the extruder generates an extruder barrel exit pressure of from about 500 to about 3000 psig, and more preferably an extruder barrel exit pressure of from about 600 to about 1000 psig is generated.

The extruder heats the mixture as it passes through the extruder further denaturing the protein in the mixture. Passing through the extruder the denatured protein is restructured or reconfigured to produce a structured protein material with protein fibers substantially aligned. The extruder includes a means for heating the mixture to temperatures of from about 100° C. to about 180° C. Preferably the means for heating the mixture in the extruder comprises extruder barrel jackets into which heating or cooling media such as steam or water may be introduced to control the temperature of the mixture passing through the extruder. The extruder also includes steam injection ports for directly injecting steam into the mixture within the extruder. The extruder may also include colorant injection ports for directly injecting colorant into the mixture within the extruder. The extruder preferably includes multiple heating zones that can be controlled to independent temperatures, where the temperatures of the heating zones are preferably set to increase the temperature of the mixture as it proceeds through the extruder. In one embodiment, the extruder may be set in a four temperature zone arrangement, where the first zone (adjacent the extruder inlet port) is set to a temperature of from about 80° C. to about 100° C., the second zone is set to a temperature of from about 100° C. to 135° C., the third zone is set to a temperature of from 135° C. to about 150° C., and the fourth zone (adjacent the extruder exit port) is set to a temperature of from 150° C. to 180° C. The extruder may be set in other temperature zone arrangements, as desired. In another embodiment, the extruder may be set in a five temperature zone arrangement, where the first zone is set to a temperature of about 25° C., the second zone is set to a temperature of about 50° C., the third zone is set to a temperature of about 95° C., the fourth zone is set to a temperature of about 130° C., and the fifth zone is set to a temperature of about 150° C. In still another embodiment, the extruder may be set in a six temperature zone arrangement, where the first zone is set to a temperature of about 90° C., the second zone is set to a temperature of about 100° C., the third zone is set to a temperature of about 105° C., the fourth zone is set to a temperature of about 100° C., the fifth zone is set to a temperature of about 120° C., and the sixth zone is set to a temperature of about 130° C.

The mixture forms a melted plasticized mass in the extruder. A die assembly is attached to the extruder in an arrangement that permits the plasticized mixture to flow from the extruder exit port into the die assembly and produces substantial alignment of the protein fibers within the plasticized mixture as it flows through the die assembly. The die assembly may include either a faceplate die or a peripheral die.

The width and height dimensions of the die aperture(s) are selected and set prior to extrusion of the mixture to provide the fibrous material extrudate with the desired dimensions. The width of the die aperture(s) may be set so that the extrudate resembles from a cubic chunk of meat to a steak filet, where widening the width of the die aperture(s) decreases the cubic chunk-like nature of the extrudate and increases the filet-like nature of the extrudate. Preferably the width of the die aperture(s) is/are set to a width of from about 5 millimeters to about 40 millimeters.

The height dimension of the die aperture(s) may be set to provide the desired thickness of the extrudate. The height of the aperture(s) may be set to provide a very thin extrudate or a thick extrudate. Preferably, the height of the die aperture(s) may be set to from about 1 millimeter to about 30 millimeters, and more preferably from about 8 millimeters to about 16 millimeters.

It is also contemplated that the die aperture(s) may be round. The diameter of the die aperture(s) may be set to provide the desired thickness of the extrudate. The diameter of the aperture(s) may be set to provide a very thin extrudate or a thick extrudate. Preferably, the diameter of the die aperture(s) may be set to from about 1 millimeter to about 30 millimeters, and more preferably from about 8 millimeters to about 16 millimeters.

Referring to the drawings (FIGS. 3-8), one embodiment of the peripheral die assembly is illustrated and generally indicated as 10 in FIG. 3. The peripheral die assembly 10 may be used in an extrusion process for extruding an extrusion, such as a plant protein-water mixture, in a manner that causes substantial parallel alignment of the protein fibers of the extrusion as shall be discussed in greater detail below. In the alternative, the extrusion may be made from a meat and/or plant protein-water mixture.

As shown in FIGS. 3 and 4, the peripheral die assembly 10 may include a die sleeve 12 having a cylindrical-shaped two-part sleeve die body 17. The sleeve die body 17 may include a rear portion 18 coupled to an end plate 20 that collectively define an internal area 31 in communication with opposing openings 72, 74. The die sleeve 12 may be adapted to receive a die insert 14 and a die cone 16 for providing the necessary structural elements to facilitate substantially parallel flow of the extrusion through the peripheral die assembly 10 during the extrusion process.

In one embodiment, the end plate 20 of the die sleeve 12 may be secured to a die cone 16 adapted to interface with the die insert 14 when the end plate 20 is secured to the rear portion 18 of the die sleeve 12 during assembly of the peripheral die assembly 10. As further shown, the rear portion 18 of die sleeve 12 defines a plurality of circular-shaped outlets 24 along the sleeve body 17 which are adapted to provide a conduit for the egress of extrusion from the peripheral die assembly 10 during the extrusion process. In the alternative, the plurality of outlets 24 may have different configurations, such as square, rectangular, scalloped or irregular. As further shown, the rear portion 18 of the die sleeve 12 may include a circular flange 37 that surrounds opening 72 and defines a pair of opposing slots 82A and 82B that are used to properly align the die sleeve 12 when engaging the die sleeve 12 to the extruding apparatus (not shown).

Referring to FIGS. 3-8, one embodiment of the die insert 14 may include a cylindrical-shaped die insert body 19 having a front face 27 in communication with an opposing rear face 29 through a throat 34 defined between the rear and front faces 27, 29. The front face 27 of the die insert 14 may define a slanted bottom portion 64 in communication with a plurality of raised flow diverters 38 that are spaced circumferentially around the front face 27 of the die insert body 19 and which surrounds an inner space 44 that communicates with throat 34. In one embodiment, the flow diverters 38 may have a pie-shaped configuration, although other embodiments may have other configurations adapted to divert and funnel the flow of the extrusion through the outlets 24 of the peripheral die assembly 10. In addition, the front face 27 of the die insert 14 defines a plurality of openings 70 adapted to communicate with a respective outlet 24 with the openings 70 being circumferentially spaced around the peripheral edge of the die insert 14.

Referring to FIGS. 3, 4, and 7 the throat 34 defined between the rear and front faces 27, 29 of the die insert 14 communicates with an opening 36 (FIG. 5) which is in communication with a well 52 (FIGS. 5 and 6) defined along the rear face 29 of die insert body 19. In one embodiment, the well 52 has a generally bowl-shaped configuration surrounded by a flange 90 (FIG. 5). The well 52 may be adapted to permit the extrusion to enter the throat 34 and flow into the inner space 44 (FIG. 7) through opening 36 having substantially parallel flow as the extrusion enters the die insert 14 from an extrusion apparatus (not shown). In other embodiments, the well 52 may be sized and shaped to different configurations suitable for permitting substantially parallel flow of the extrusion through the throat 34 as the extrusion enters the front face 29 of the die insert 14.

As shown specifically in FIGS. 7 and 8, each flow diverter 38 has a raised configuration defining a curved back portion 68 having a beveled peripheral edge 46 in communication with opposing side walls 50 that meet at an apex 66. In addition, each flow diverter 38 defines a pie-shaped surface 48 adapted to interface with die cone 16 (FIG. 4). As further shown, the opposing side walls 50 of adjacent flow diverters 38 and the bottom portion 64 of the die insert 14 collectively define a tapered flow pathway 42 that forms a portion of a flow channel 40 (FIG. 5) when the peripheral die assembly 10 is fully assembled. The flow pathway 42 may be in communication with an entrance 84 at one end and a respective outlet 24 at a terminal end of the flow pathway 42

As further shown, each flow pathway 42 has a three-sided tapered configuration collectively defined between the opposing side walls 50 of adjacent flow diverters 38 and the slanted configuration of bottom portion 64 of the die insert 14. In one embodiment, this three-sided tapered configuration gradually tapers inwardly on all three sides of the flow pathway 42 from the entrance 84 to the outlet 24.

In an embodiment, the front face 27 of the die insert 14 may include eight flow diverters 38 that define a respective flow pathway 42 between adjacent flow diverters 38 for a total of eight flow pathways 42. However, other embodiments may define at least two or more flow diverters 38 circumferentially spaced around the peripheral edge of the 76 (FIG. 4) of the die insert 14 in order to provide at least two or more flow pathways 42 along the front face 27 of the die insert 14.

During the extrusion process, as shown in FIGS. 5, 6, 7, and 8, the peripheral die assembly 10 may be operatively engaged with an extruding apparatus (not shown) that produces an extrusion that contacts the well 52 defined by the rear face 29 of the die insert 14 and flows into the throat 34 and enters the inner space opening 36 as indicated by flow path A. The extrusion may enter the inner space 44 defined by the die insert 14 and enter the entrance 84 of each tapered flow channel 42. As noted above, the extrusion then flows through each flow channel 42 and exits from a respective outlet 24 in a manner that causes the substantial alignment of the plant protein fibers in the extrusion produced by the peripheral die assembly 10.

Examples of peripheral die assemblies suitable for use in this invention to produce the structured protein fibers that are substantially aligned are described in U.S. Pat. App. No. 60/882,662, and U.S. patent application Ser. No. 11/964,538, which are hereby incorporated by reference in their entirety.

The extrudate may be cut after exiting the die assembly. Suitable apparatuses for cutting the extrudate include flexible knives manufactured by Wenger Manufacturing, Inc. (Sabetha, Kans.) and Clextral, Inc. (Tampa, Fla.). Typically, the speed of the cutting apparatus is from about 1000 rpm to about 2500 rpm. In an exemplary embodiment, the speed of the cutting apparatus is about 1600 rpm. A delayed cut can also be done to the extrudate. One such example of a delayed cut device is a guillotine device.

The dryer, if one is used, generally comprises a plurality of drying zones in which the air temperature may vary. Examples known in the art include convection dryers. The extrudate will be present in the dryer for a time sufficient to produce an extrudate having the desired moisture content. Thus, the temperature of the air is not important; if a lower temperature is used (such as 50° C.) longer drying times will be required than if a higher temperature is used. Generally, the temperature of the air within one or more of the zones will be from about 100° C. to about 185° C. At such temperatures the extrudate is generally dried for at least about 45 minutes and more generally, for at least about 65 minutes. Suitable dryers include those manufactured by CPM Wolverine Proctor (Lexington, N.C.), National Drying Machinery Co. (Trevose, Pa.), Wenger (Sabetha, Kans.), Clextral (Tampa, Fla.), and Buehler (Lake Bluff, Ill.).

Another option is to use microwave assisted drying. In this embodiment, a combination of convective and microwave heating is used to dry the product to the desired moisture. Microwave assisted drying is accomplished by simultaneously using forced-air convective heating and drying to the surface of the product while at the same time exposing the product to microwave heating that forces the moisture that remains in the product to the surface whereby the convective heating and drying continues to dry the product. The convective dryer parameters are the same as discussed previously. The addition is the microwave-heating element, with the power of the microwave being adjusted dependent on the product to be dried as well as the desired final product moisture. As an example the product can be conveyed through an oven that contains a tunnel that is equipped with wave-guides to feed the microwave energy to the product and chokes designed to prevent the microwaves from leaving the oven. As the product is conveyed through the tunnel the convective and microwave heating simultaneously work to lower the moisture content of the product thereby drying. Typically, the air temperature is 50° C. to about 80° C., and the microwave power is varied dependent on the product, the time the product is in the oven, and the final moisture content desired.

The desired moisture content may vary widely depending on the intended application of the extrudate. Generally speaking, the extruded material has a moisture content of less than 10% moisture. As a further example the material may have a moisture content typically from about 5% to about 13% by weight, if dried. Although not required in order to separate the fibers, hydrating in water until the water is absorbed is one way to separate the fibers. If the protein material is not dried or not fully dried and is to be used immediately, its moisture content can be higher, generally from about 16% to about 30% by weight. If a protein material with high moisture content is produced, the protein material may require immediate use or refrigeration to ensure product freshness, and minimize spoilage.

The extrudate may further be comminuted to reduce the average particle size of the extrudate. Typically, the reduced extrudate has an average particle size of from about 0.1 mm to about 40.0 mm. In one example, the reduced extrudate has an average particle size of from about 5.0 mm to about 30.0 mm. In another embodiment, the reduced extrudate has an average particle size of from about 0.5 mm to about 20.0 mm. In a further embodiment, the reduced extrudate has an average particle size of from about 0.5 mm to about 15.0 mm. In an additional embodiment, the reduced extrudate has an average particle size of from about 0.75 mm to about 10.0 mm. In yet another embodiment, the reduced extrudate has an average particle size of from about 1.0 mm to about 5.0 mm. Suitable apparatus for reducing particle size include hammer mills, such as Mikro Hammer Mills manufactured by Hosokawa Micron Ltd. (England), Fitzmill® manufactured by the Fitzpatrick Company (Elmhurst, Ill.), Comitrol® processors made by Urschel Laboratories, Inc. (Valparaiso, Ind.), and roller mills such as RossKamp Roller Mills manufactured by RossKamp Champion (Waterloo, Ill.).

(d) Characterization of the Structured Protein Products

The extrudates typically comprise the structured protein products having protein fibers that are substantially aligned. In the context of this invention “substantially aligned” generally refers to the arrangement of protein fibers such that a significantly high percentage of the protein fibers forming the structured protein product are contiguous to each other at less than approximately a 45° angle when viewed in a horizontal plane. Typically, an average of at least 55% of the protein fibers comprising the structured protein product are substantially aligned. In another embodiment, an average of at least 60% of the protein fibers comprising the structured protein product are substantially aligned. In a further embodiment, an average of at least 70% of the protein fibers comprising the structured protein product are substantially aligned. In an additional embodiment, an average of at least 80% of the protein fibers comprising the structured protein product are substantially aligned. In yet another embodiment, an average of at least 90% of the protein fibers comprising the structured protein product are substantially aligned.

Methods for determining the degree of protein fiber alignment are known in the art and include visual determinations based upon micrographic images. By way of example, FIGS. 1 and 2 depict micrographic images that illustrate the difference between a structured protein product having substantially aligned protein fibers compared to a protein product having protein fibers that are significantly crosshatched. FIG. 1 depicts a structured protein product prepared according to the extrusion process detailed above having protein fibers that are substantially aligned. Contrastingly, FIG. 2 depicts a protein product containing protein fibers that are significantly crosshatched and not substantially aligned. Because the protein fibers are substantially aligned, as shown in FIG. 1, the structured protein products utilized in the invention generally have the texture and consistency of cooked muscle meat. In contrast, extrudates having protein fibers that are randomly oriented or crosshatched generally have a texture that is soft or spongy.

In addition to having protein fibers that are substantially aligned, the structured protein products also typically have shear strength substantially similar to whole meat muscle. In this context of the invention, the term “shear strength” provides one means to quantify the formation of a sufficient fibrous network to impart whole-muscle like texture and appearance to the structured protein product. Shear strength is the maximum force in grams needed to shear through a given sample. A method for measuring shear strength is described in Example 1.

Generally speaking, the structured protein products of the invention will have average shear strength of at least 1400 grams. In an additional embodiment, the structured protein products will have average shear strength of from about 1500 to about 1800 grams. In yet another embodiment, the structured protein products will have average shear strength of from about 1800 to about 2000 grams. In a further embodiment, the structured protein products will have average shear strength of from about 2000 to about 2600 grams. In an additional embodiment, the structured protein products will have average shear strength of at least 2200 grams. In a further embodiment, the structured protein products will have average shear strength of at least 2300 grams. In yet another embodiment, the structured protein products will have average shear strength of at least 2400 grams. In still another embodiment, the structured protein products will have average shear strength of at least 2500 grams. In a further embodiment, the structured protein products will have average shear strength of at least 2600 grams.

A means to quantify the size of the protein fibers formed in the structured protein products may be done by a shred characterization test. Shred characterization is a test that generally determines the percentage of large pieces formed in the structured protein product. In an indirect manner, percentage of shred characterization provides an additional means to quantify the degree of protein fiber alignment in a structured protein product. Generally speaking, as the percentage of large pieces increases, the degree of protein fibers that are aligned within a structured protein product also typically increases. Conversely, as the percentage of large pieces decreases, the degree of protein fibers that are aligned within a structured protein product also typically decreases.

A method for determining shred characterization is detailed in Example 2. The structured protein products of the invention typically have an average shred characterization of at least 10% by weight of large pieces. In a further embodiment, the structured protein products have an average shred characterization of from about 10% to about 15% by weight of large pieces. In another embodiment, the structured protein products have an average shred characterization of from about 15% to about 20% by weight of large pieces. In yet another embodiment, the structured protein products have an average shred characterization of from about 20% to about 25% by weight of large pieces. In another embodiment, the average shred characterization is at least 20% by weight, at least 21% by weight, at least 22% by weight, at least 23% by weight, at least 24% by weight, at least 25% by weight, or at least 26% by weight large pieces.

Suitable structured protein products of the invention generally have protein fibers that are substantially aligned, have average shear strength of at least 1400 grams, and have an average shred characterization of at least 10% by weight large pieces. More typically, the structured protein products will have protein fibers that are at least 55% aligned, have average shear strength of at least 1800 grams and have an average shred characterization of at least 15% by weight large pieces. In exemplary embodiment, the structured protein products will have protein fibers that are at least 55% aligned, have average shear strength of at least 2000 grams, and have an average shred characterization of at least 17% by weight large pieces. In another exemplary embodiment, the structured protein products will have protein fibers that are at least 55% aligned, have average shear strength of at least 2200 grams, and have an average shred characterization of at least 20% by weight large pieces.

B. Combinations of Protein Containing Materials.

It is contemplated that the dried food compositions may include any combination of the animal meat, animal derived protein, or plant derived protein. In an exemplary embodiment, the formulation will include a structured protein product produced by the extrusion process detailed above. Typically, the amount of structured protein product in relation to the amount of animal meat in the dried food compositions can and will vary depending upon the composition's intended use. By way of example, when a relatively small degree of animal meat is desired, the concentration of animal meat in the dried food composition may be about 45%, 40%, 35%, 30%, 25%, 20%, 15%, 10%, 5%, 2%, or 0% by weight. Alternatively, when a dried food composition having a relatively high degree of animal meat is desired, the concentration of animal meat in the dried food composition may be about 50%, 55%, 60%, 65%, 70%, 75%, 80%, 85%, 90% or 95% by weight. Consequently, the concentration of structured protein product in the dried food composition may be about 5%, 10%, 15%, 20%, 25%, 30%, 35%, 40%, 45%, 50%, 55%, 60%, 65%, 70%, 75%, 80%, 85%, 90%, 95%, or 99% by weight. In one embodiment, the dried food composition is a vegetarian composition having a concentration of animal meat of about 0% by weight and a concentration of a meat-free structured protein product of about 30% to about 80% by weight. In a further embodiment, the dried food composition comprises from about 40% to about 60% by weight of the structured protein product and from about 40% to about 60% by weight of animal meat.

The dried food compositions can include an amount of animal meat dependent on the desired end product. As was previously discussed the animal meat can be a meat or meat form used in the food industry. Non-limiting examples include any meat or meat product discussed in I(1)(A)(a)(i) above.

### 2. Fat

The dried food compositions may have a fat content that varies widely. Typically, the dried food compositions have a fat content from about 1% to about 75% by weight of the composition. More typically, the amount may be from about 1% to about 40% by weight of the composition. For example, the amount of fat may be from about 1% to about 5%, from about 5% to about 10%, from about 10% to about 15%, from about 15% to about 20%, from about 20% to about 25%, from about 25% to about 30%, from about 30% to about 35%, from about 35% to about 40%, or greater than 40% by weight of the composition.

In one embodiment, the dried food composition comprises a dairy-based fat. Non-limiting examples of suitable dairy-based fat sources include butter, cheese, and cream. In another embodiment, the dried food composition comprises a vegetable based fat. Non-limiting examples of suitable vegetable based fat include liquid, solid, and semi-solid hydrogenated or partially hydrogenated vegetable oil such as palm oil, coconut oil, cottonseed oil, soybean oil, corn oil, rice oil, peanut oil, canola oil, sunflower oil, safflower, flax seed oil, grape seed oil, olive oil, and mixtures thereof. In still another embodiment, the dried food composition comprises an animal based fat. Non-limiting examples of suitable animal based fat includes tallow, lard, chicken fat, fish oil, and mixtures thereof. Typically, the dried food compositions will comprise a plant derived fat source when it is formulated as a vegetarian composition.

### 3. Carbohydrate and Fiber Sources

While it is contemplated that the macronutrients detailed above will contain carbohydrates materials such as grains, starches, and fibers, additional sources may be included. Suitable examples of other carbohydrate sources include kamut, brown rice, oats, barley, rice, corn, milo, potatoes, corn syrup, sugar, maltodextrin, molasses, whole wheat, quinoa, sunflower seed meal, flaxseed meal, garlic, red beets, soybean, spinach, carrot, broccoli, blueberries, rosemary, and mixtures thereof. The amount of carbohydrate may range from about 1% to about 99% by weight carbohydrate, more preferably from about 5% to about 50% by weight carbohydrate.

Suitable examples of fiber sources include cellulose, hemi-cellulose, corncobs, soy hulls, okara (soy cotyledon fiber), wheat bran, psyllium seed husk, oat bran, peanut hulls, rice hulls, and yeast cell walls. Alternatively, soluble fibers such as polydextrose, Fibersol 2™ (Matsutani America) may also be used. The dried food compositions may comprise from about 1% to about 20% by weight fiber, and more typically from about 1% to about 10% by weight fiber.

### (II) Micronutrients

The dried food composition generally will comprise micronutrients including vitamins and minerals, antioxidants, amino acids, and combinations thereof. In an exemplary embodiment, the micronutrient will include an omega-3 fatty acid.

The vitamins typically will include a mixture of fat-soluble and water soluble vitamins. Suitable vitamins include vitamin C, vitamin A, vitamin E, vitamin B12, vitamin K, riboflavin, niacin, vitamin D, vitamin B6, folic acid, pyridoxine, thiamine, pantothenic acid, biotin, and combinations thereof. The form of the vitamin may include salts of the vitamin, derivatives of the vitamin, compounds having the same or similar activity of the vitamin, and metabolites of the vitamin.

Suitable minerals may include one or more minerals or mineral sources. Non-limiting examples of minerals include, without limitation, chloride, sodium, calcium, iron, chromium, copper, iodine, zinc, magnesium, manganese, molybdenum, phosphorus, potassium, selenium, and combinations thereof. Suitable forms of any of the foregoing minerals include soluble mineral salts, slightly soluble mineral salts, insoluble mineral salts, chelated minerals, mineral complexes, non-reactive minerals such as carbonyl minerals, reduced minerals, and combinations thereof.

In a further embodiment, the dried food compositions may further comprise an antioxidant. The antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-caraotene, beta-apo-carotenoic acid, carnosol, carvacrol, catechins, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids, flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, ice bran extract, lactic acid and its salts, lecithin, lecithin citrate; R-alpha-lipoic acid, lutein, lycopene, malic acid, maltol, 5-methoxy tryptamine, methyl gallate, monoglyceride citrate-; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., lonox 100), 2,4-(tris-3′,5′-bi-tert-butyl-4′-hydroxybenzyl)-mesitylene (i.e., lonox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, and combinations thereof. The concentration of an antioxidant in a dried food composition may range from about 0.0001% to about 20% by weight. In another embodiment, the concentration of an antioxidant in a dried food composition may range from about 0.001% to about 5% by weight. In yet another embodiment, the concentration of an antioxidant in a dried food composition may range from about 0.01% to about 1% by weight.

An herb may be suitable for use in certain embodiments. Herbs that may be added include basil, celery leaves, chervil, chives, cilantro, parsley, oregano, tarragon, thyme, and combinations thereof.

The dried food compositions may further include a polyunsaturated fatty acid (PUFA), which has at least two carbon-carbon double bonds generally in the cis-configuration. The PUFA may be a long chain fatty acid having at least 18 carbons atoms. In an exemplary embodiment, the PUFA may be an omega-3 fatty acid in which the first double bond occurs in the third carbon-carbon bond from the methyl end of the carbon chain (i.e., opposite the carboxyl acid group). Examples of omega-3 fatty acids include alpha-linolenic acid (18:3, ALA), stearidonic acid (18:4), eicosatetraenoic acid (20:4), eicosapentaenoic acid (20:5; EPA), docosatetraenoic acid (22:4), n-3 docosapentaenoic acid (22:5; n-3DPA), docosahexaenoic acid (22:6; DHA), and combinations thereof. The PUFA may also be an omega-6 fatty acid, in which the first double bond occurs in the sixth carbon-carbon bond from the methyl end. Examples of omega-6 fatty acids include linoleic acid (18:2), gamma-linolenic acid (18:3), eicosadienoic acid (20:2), dihomo-gamma-linolenic acid (20:3), arachidonic acid (20:4), docosadienoic acid (22:2), adrenic acid (22:4), n-6 docosapentaenoic acid (22:5), and combinations thereof. The fatty acid may also be an omega-9 fatty acid, such as oleic:acid (18:1), eicosenoic acid (20:1), mead acid (20:3), erucic acid (22:1), nervonic acid (24:1), and combinations thereof.

### (III) Dried Food Compositions/Products

The macronutrients and micronutrients detailed above may be formulated into a variety of dried food products. In an exemplary embodiment, the formulation, irrespective of the dried food product, will comprise an amount of the structured protein product detailed in (I)(A)(iii). Typically, the amount of structured protein product in the dried food composition, such as the ones described below, can and will vary depending upon the composition's intended use. In an exemplary embodiment, the dried food composition comprises from about 1% to about 99% by weight of the structured protein product, or from about 1% to about 75% by weight of the structured protein product, or from about 1% to about 50% by weight of the structured protein product, or from about 1% to about 25% by weight of the structured protein product, or from about 1% to about 15% by weight of the structured protein product.

By way of non-limiting example, the final product may be a dried food, including an intermediate moisture food product that simulates a dried meat product such as a jerky style meat strip, a kebab product, a shredded product, a chunk meat product, a nugget product, a stick in casing product, or a crumbled topping product.

The dried food products may be produced in a variety of shapes. Non-limiting examples of shapes include bone shaped, chop shaped, round, triangular, chicken bone shaped, square, rectangular, strip shaped, and tubular. The different shapes may be produced simultaneously by using variously shaped molds or cavities upon a single die roll. Furthermore, the dried food products may be embossed or impressed with a logo or design contained in the cavities or molds of the die roll. In one embodiment, the dried food composition may be made into shelf stable shredded meats and crumbles for use as high protein food toppings. Such food toppings include, for example, rice topping, salad topping, potato topping, pizza topping, yoghurt topping, and dessert topping. In another embodiment, the dried food composition may be made into a jerky style meat snack.

Typically the dried food products exhibit shelf stability under unrefrigerated conditions for at least about six months and preferably at least about twelve months in proper moisture proof packaging, such as foil-lined bags.

### (IV) Preparation of a Dried Food Composition/Product

The dried food compositions/products detailed in III, generally include a structured protein product to meet at least a portion of the recited protein requirement. Typically, the process of making a food composition involves hydrating the structured protein product and reducing its size, adding a firming agent, optionally coloring and flavoring it, and then blending it with the rest of the ingredients that form the food composition. The composition is then formed into the desired shape, cooked, and dried to achieve a water activity of between about 0.1 and about 0.95. In one embodiment, the dried composition is an intermediate moisture food product having a water activity of between about 0.5 and about 0.95. In another embodiment, the dried composition has a water activity of less than 0.5. At a water activity range from 0.7 to 0.95, a proper package and or an oxygen scavenger may be required to remove oxygen, thereby inhibiting the growth of molds and pathogens.

The amount of water added to the structured protein product can and will vary depending on the dried food composition desired. The water may be added to the structured protein product. Alternatively, water, structured protein product, and additional ingredients forming the food composition may be mixed at the same time. Irrespective of when the ingredients are combined, the dried food composition generally has a moisture content of less than about 25% by weight. In one embodiment, the dry dried food composition has a moisture content of about 10% to about 20% by weight. In an exemplary embodiment, the dry dried food composition has a moisture content of less than about 12% by weight.

It is also envisioned that the structured protein product may be combined with a firming agent. A firming agent is added to strengthen the texture of the structured soy protein product. It typically reduces the solubility of soy protein, resulting in reduced water retention and enhanced water release. In the dried composition, a minimal amount of water is formulated. Thus the released water from the hydrated structured soy protein becomes available to meat and other ingredients during the meat extraction step. By way of example, the dried food composition may include a non-acid firming agent or an acid firming agent. Suitable examples of non-acid firming agents include calcium chloride, calcium sulfate, calcium hydrogen sulphite, mono-calcium citrate, di-calcium citrate, tri-calcium citrate, mono-calcium phosphate, di-calcium phosphate, tri-calcium phosphate, calcium gluconate, natural nigari (sea salt), magnesium chloride, magnesium sulfate, and combinations thereof. Suitable examples of acid firming agents include gluconic acid, lactic acid, citric acid, phosphoric acid, malic acid, tartaric acid, and combinations thereof.

As will be appreciated by a skilled artisan, the amount of firming agent utilized in the invention can and will vary depending upon several parameters, including, the agent selected, the desired texture, and the stage of manufacture at which the agent is added. By way of non-limiting example, the amount of firming agent combined with the protein material may range from about 0.1% to about 15% on a dry matter basis. In another embodiment, the amount of firming agent may range from about 0.5% to about 10% on a dry matter basis. In an additional embodiment, the amount of firming agent may range from about 1% to about 5% on a dry matter basis. In other embodiments, the amount of firming agent may range from about 2% to about 3% on a dry matter basis. In another embodiment, the amount of firming agent is about 2.5% on a dry matter basis.

It is also envisioned that the structured protein product may be combined with a suitable coloring agent such that the color of the composition resembles the color of animal meat. In one embodiment, the colorant may be combined with the protein-containing material and other ingredients prior to being fed into the extruder. In another embodiment, the colorant may be combined with the protein-containing material and other ingredients after being fed into the extruder. In yet another embodiment, the colorant may be combined with the protein-containing material and other ingredients after it has been extruded. The dried food compositions of the invention may be colored to resemble dark animal meat or light animal meat. By way of example, the dried food composition may be colored with a natural colorant, a combination of natural colorants, an artificial colorant, a combination of artificial colorants, or a combination of natural and artificial colorants. The colorant(s) may be a natural colorant, a combination of natural colorants, an artificial colorant, a combination of artificial colorants, or a combination of natural and artificial colorants. Suitable examples of natural colorants approved for use in food include annatto (reddish-orange), anthocyanins (red to blue, depends upon pH), beet juice, beta-carotene (orange), beta-APO 8 carotenal (orange), black currant, burnt sugar; canthaxanthin (pink-red), caramel, carmine/carminic acid (bright red), cochineal extract (red), curcumin (yellow-orange); lac (scarlet red), lutein (red-orange); lycopene (orange-red), mixed carotenoids (orange), monascus (red-purple, from fermented red rice), paprika, red cabbage juice, riboflavin (yellow), saffron, titanium dioxide (white), turmeric (yellow-orange), and combinations thereof. Suitable examples of artificial colorants approved for food use in the United States include FD&C Red No. 3 (Erythrosine), FD&C Red No. 40 (Allura Red), FD&C Yellow No. 5 (Tartrazine), FD&C Yellow No. 6 (Sunset Yellow FCF), FD&C Blue No. 1 (Brilliant Blue FCF), FD&C Blue No. 2 (Indigotine), and combinations thereof. Artificial colorants that may be used in other countries include CI Food Red 3 (Carmoisine), CI Food Red 7 (Ponceau 4R), CI Food Red 9 (Amaranth), CI Food Yellow 13 (Quinoline Yellow), CI Food Blue 5 (Patent Blue V), and combinations thereof. Food colorants may be dyes, which are powders, granules, or liquids that are soluble in water. Alternatively, natural and artificial food colorants may be lake colors, which are combinations of dyes and insoluble materials. Lake colors are not oil soluble, but are oil dispersible; tinting by dispersion.

The type of colorant(s) and the concentration of the colorant(s) may be adjusted to match the color of the animal meat to be simulated. Suitable colorant(s) may be combined with the protein-containing materials in a variety of forms. Non-limiting examples include solid, semi-solid, powdered, liquid, and gel. The type and concentration of colorant(s) utilized may vary depending on the protein-containing materials used and the desired color of the colored structured protein product. Typically, the concentration of colorant(s) may range from about 0.001% to about 5.0% by weight. In one embodiment, the concentration of colorant(s) may range from about 0.01% to about 4.0% by weight. In another embodiment, the concentration of colorant(s) may range from about 0.05% to about 3.0% by weight. In still another embodiment, the concentration of colorant(s) may range from about 0.1% to about 3.0% by weight. In a further embodiment, the concentration of colorant(s) may range from about 0.5% to about 2.0% by weight. In another embodiment, the concentration of colorant(s) may range from about 0.75% to about 1.0% by weight.

The color system may further comprise a pH regulator to maintain the pH in the optimal range for the colorant. The pH regulator may be an acidulent. Examples of acidulents that may be added to food include hydrochloric acid, citric acid, acetic acid (vinegar), tartaric acid, malic acid, fumaric acid, lactic acid, phosphoric acid, sorbic acid, gluconic acid, sodium acid pyrophosphate, benzoic acid, and combinations thereof. Typically, the concentration of the acidulent in the dried food composition may range from about 0.001% to about 5% by weight. In one embodiment, the concentration of the acidulent may range from about 0.01% to about 2% by weight. In another embodiment, the final concentration of the acidulent may range from about 0.1% to about 1% by weight. The pH regulator may also be a pH-raising agent, such as sodium hydroxide, disodium diphosphate, sodium tripolyphosphate, sodium carbonate, and combinations thereof.

The coloring composition of the present invention may be prepared by combining the components using processes and procedures known to those of ordinary skill in the art. The components are typically available in either a liquid form or a powder form, and often in both forms. The components can be mixed directly to form the coloring composition, but preferably the ingredients of the coloring composition are combined in an aqueous solution at a total concentration of about 10% to about 25% by weight, where the aqueous coloring solution can be conveniently added to a quantity of water for mixing with and coloring a structured protein product.

It is also envisioned that the structured protein product may be combined with a suitable pH-lowering agent to increase the chew or toughness of the product. The pH-lowering agent may be suitably contacted with the dried food composition at various stages of the composition's manufacture. In one embodiment, the pH-lowering agent is contacted with the plant protein material and the mixture is then extruded according to the process detailed herein. Alternatively, the pH-lowering agent may be contacted with the structured plant protein product after it has been extruded.

Irrespective of the stage of manufacture at which the pH-lowering agent is introduced, suitable agents include those that will lower the pH of the composition to below approximately 7.0. In one embodiment, the pH is below approximately 7.0. In another embodiment, the pH is lowered to between about 6.0 to about 7.0. In still another embodiment, the pH is lowered to below approximately 6.0.

In another embodiment, the pH is lowered to between about 5.0 and about 6.0. In one alternative of this embodiment, the pH is lowered to between about 5.2 to about 5.9. In still another alternative of this embodiment, the pH is lowered to between about 5.4 to about 5.8. In an additional alternative of this embodiment, the pH is lowered to about 5.6. In another embodiment, the pH is lowered to below approximately 5.0. In a further embodiment, the pH is lowered to between about 4.0 to about 5.0. In still another embodiment, the pH is lowered to below approximately 4.0.

Several pH-lowering agents are suitable for use in the invention. The pH-lowering agent may be organic. Alternatively, the pH-lowering agent may be inorganic. In exemplary embodiments, the pH-lowering agent is a food grade edible acid. Non-limiting acids suitable for use in the invention include acetic, lactic, hydrochloric, phosphoric, citric, tartaric, malic, gluconic, and combinations thereof. In an exemplary embodiment, the pH-lowering agent is lactic acid.

As will be appreciated by a skilled artisan, the amount of pH-lowering agent utilized in the invention can and will vary depending upon several parameters, including, the agent selected, the desired pH, and the stage of manufacture at which the agent is added. By way of non-limiting example, the amount of pH-lowering agent combined with the protein material may range from about 0.01% to about 10% on a dry matter basis. In another embodiment, the amount of pH-lowering agent may range from about 0.1% to about 10% on a dry matter basis. In an additional embodiment, the amount of pH-lowering agent may range from about 0.5% to about 5% on a dry matter basis. In other embodiments, the amount of pH-lowering agent may range from about 0.5% to about 2.5% on a dry matter basis.

The dried food compositions may optionally include a variety of flavorings. Suitable flavoring agents include animal meat flavor, animal meat oil, spice extracts, spice oils, natural smoke solutions, natural smoke extracts, yeast extracts, sherry, mint, brown sugar, honey, coffee, chocolate, cinnamon, tea, and combinations thereof. The flavors and spices may also be available in the form of olio-resins and aqua-resins. Other flavoring agents include onion flavor, garlic flavor, or herb flavor. In an alternative embodiment, the flavoring agent may be nutty, sweet, or fruity. Non-limiting examples of suitable fruit flavors include apple, apricot, avocado, banana, blackberry, black cherry, blueberry, boysenberry, cantaloupe, cherry, coconut, cranberry, fig, grape, grapefruit, green apple, honeydew, kiwi, lemon, lime, mango, mixed berry, orange, peach, persimmon, pineapple, raspberry, strawberry, watermelon, and combinations thereof. The dried food compositions may further include flavor enhancers. Non-limiting examples of suitable flavor enhancers include sodium chloride, potassium choloride, Morton® Lite Salt, glutamic acid salts, glycine salts, guanylic acid salts, inosinic acid salts, and 5-ribonucleotide salts, yeast extract, shiitake mushroom extract, dried bonito extract, hydrolyzed vegetable protein, kelp extract, and combinations thereof. The dried food composition may also utilize various sauces and marinades which may be made by fermentation or blending flavors, spices, oils, water, flavor enhancers, antioxidants, acidulents, preservatives, sweeteners, and combinations thereof.

It is also envisioned that the dried food compositions, including those classified as intermediate moisture foods, may include a suitable humectant to obtain the desired moisture content and water activity. Suitable examples of humectants include sugars, such as sucrose dextrose, fructose, xylose, maple syrup, corn syrup, honey, maltose, molasses, and combinations thereof; sugar alcohols, such as erythritol, hydrogenated starch hydrosylate, isomalt, lactitol, maltitol, mannitol, sorbitol, xylitol and combinations thereof; polydextrose; glycerine; propylene glycol; triacetin; potassium lactate; sodium lactate, and combinations thereof. By way of non-limiting example, the amount of humectant combined with the protein material may range from about 0.1% to about 15% on a dry matter basis. In another embodiment, the amount of humectant may range from about 0.5% to about 10% on a dry matter basis. In an additional embodiment, the amount of humectant may range from about 1% to about 5% on a dry matter basis. In other embodiments, the amount of humectant may range from about 2% to about 3% on a dry matter basis.

The dried food compositions of the invention may also comprise a preservative. Examples of preservatives that may be added to the compositions include benzoates, butylated hydroxytoluene, butylated hydroxyanisole, tert-butylhydroquinone, propylgallate, antioxidants, citric acid, ascorbic acid, EDTA (ethylenediamine tetra-acetic acid), nitrites, nitrates, propionates, sulfites, sorbic acid, potassium sorbate, sulfur dioxide, and combinations thereof. In one embodiment, the concentration of the preservative in the dried food composition may range from about 0.001% to about 5% by weight. In another embodiment, the concentration of the preservative may range from about 0.01% to about 2% by weight. In yet another embodiment, the concentration of the preservative may range from about 0.1% to about 1% by weight.

Generally speaking, dried food compositions comprising structured protein products may be combined with the macronutrients, micronutrients, and optional ingredients as detailed herein or otherwise known in the art. The dried food composition, depending upon its moisture content and water activity, may be formed, for example, into a jerky style strip product, shredded meat, a crumble, for use as a food topping, and any other dried food composition known in the food industry, according to methods generally known in the art.

### DEFINITIONS

The term “animal meat” as used herein refers to the flesh, whole meat muscle, or parts thereof derived from an animal.

The term “comminuted meat” as used herein refers to a meat paste that is recovered from an animal carcass. The meat, on the bone, or the meat plus the bone is forced through a deboning device such that meat is separated from the bone and reduced in size. Meat that is off the bone would not be further treated with a deboning device. The meat is separated from the meat/bone mixture by forcing through a cylinder with small diameter holes. The meat acts as a liquid and is forced through the holes while the remaining bone material remains behind. The fat content of the comminuted meat may be adjusted upward by the addition of animal fat.

The term “extrudate” as used herein refers to the product of extrusion. In this context, the plant protein products comprising protein fibers that are substantially aligned may be extrudates in some embodiments.

The term “fiber” as used herein refers to a plant protein product having a size of approximately 4 centimeters in length and about 0.2 centimeters in width after the shred characterization test detailed in Example 2 is performed. In this context, the term “fiber” does not include the nutrient class of fibers, such as soybean cotyledon fibers, and also does not refer to the structural formation of substantially aligned protein fibers comprising the plant protein products.

The term “firming agent” as used herein refers to a substance added to strengthen the texture of the structured protein products by decreasing water retention and enhancing moisture release of the hydrated structured soy protein product.

The term “gluten” as used herein refers to a protein fraction in cereal grain flour, such as wheat, that possesses a high content of protein as well as unique structural and adhesive properties.

The term “gluten free starch” as used herein refers to various starch products such as modified tapioca starch. Gluten free or substantially gluten free starches are made from wheat, corn, and tapioca based starches. They are gluten free because they do not contain the gluten from wheat, oats, rye or barley.

The term “humectant” as used herein refers to a substance that functions to absorb and/or promote the retention of moisture.

The term “hydration test” as used herein measures the amount of time in minutes necessary to hydrate a known amount of the protein composition.

The term “large piece” as used herein is the manner in which a colored or uncolored structured plant protein product's shred percentage is characterized. The determination of shred characterization is detailed in Example 2.

The term “mechanically deboned meat (MDM)” as used herein refers to a meat paste that is recovered from beef, pork and chicken bones using commercially available equipment. MDM is a comminuted product that is devoid of the natural fibrous texture found in intact muscles.

The term “moisture content” as used herein refers to the amount of moisture in a material. The moisture content of a material can be determined by A.O.C.S. (American Oil Chemists Society) Method Ba 2a-38 (1997), which is incorporated herein by reference in its entirety.

The term “organic” as used herein refers to food compositions that have been manufactured and handled according to specific National Organic Program requirements under 7 C.F.R. Part 205.

The term “protein content,” as for example, soy protein content as used herein, refers to the relative protein content of a material as ascertained by A.O.C.S. (American Oil Chemists Society) Official Methods Bc 4-91 (1997), Aa 5-91 (1997), or Ba 4d-90 (1997), each incorporated herein by reference in their entirety, which determine the total nitrogen content of a material sample as ammonia, and the protein content as 6.25 times the total nitrogen content of the sample.

The term “protein fiber” as used herein refers to the individual continuous filaments or discrete elongated pieces of varying lengths that together define the structure of the plant protein products of the invention. Additionally, because both the colored and uncolored structured plant protein products of the invention have protein fibers that are substantially aligned, the arrangement of the protein fibers impart the texture of whole meat muscle to the colored and uncolored structured plant protein products.

The term “shear strength” as used herein measures the ability of a textured protein to form a fibrous network with a strength high enough to impart meat-like texture and appearance to a formed product. Shear strength is measured in grams.

The term “simulated” as used herein refers to a dried food composition that contains no animal meat.

The term “soy cotyledon fiber” as used herein refers to the polysaccharide portion of soy cotyledons containing at least about 70% dietary fiber on a dry matter basin. Soy cotyledon fiber typically contains some minor amounts of soy protein, but may also be 100% fiber. Soy cotyledon fiber, as used herein, does not refer to, or include, soy hull fiber. Generally, soy cotyledon fiber is formed from soybeans by removing the hull and germ of the soybean, flaking or grinding the cotyledon and removing oil from the flaked or ground cotyledon, and separating the soy cotyledon fiber from the soy material and soluble carbohydrates of the cotyledon.

The term “soy protein concentrate” as used herein is a soy material having a protein content of from about 65% to less than about 90% soy protein on a moisture-free basis. Soy protein concentrate may also contains soy cotyledon fiber, typically from about 3.5% up to about 20% soy cotyledon fiber by weight on a moisture-free basis. A soy protein concentrate is formed from soybeans by removing the hull and germ of the soybean, flaking or grinding the cotyledon and removing oil from the flaked or ground cotyledon. Further, the soy protein and soy cotyledon fiber may be separated from the soluble carbohydrates of the cotyledon.

The term “soy flour” as used herein, refers to full fat soy flour, enzyme-active soy flour, defatted soy flour, and mixtures thereof. Defatted soy flour refers to a comminuted form of defatted soybean material, preferably containing less than about 1% oil, formed of particles having a size such that the particles can pass through a No. 100 mesh (U.S. Standard) screen. The soy cake, chips, flakes, meal, or mixture of the material are comminuted into soy flour using conventional soy grinding processes. Soy flour has a soy protein content of about 49% to about 65% on a moisture free basis. Preferably the flour is very finely ground, most preferably so that less than about 1% of the four is retained on a 300 mesh (U.S. Standard) screen. Full fat soy flour refers to ground whole soybeans containing all of the original oil, usually 18% to 20%. The flour may be enzyme-active or it may be heat-processed or toasted to minimize enzyme activity. Enzyme-active soy flour refers to a full fat soy flour that has been minimally heat-treat in order not to neutralize its natural enzyme.

The term “soy protein isolate” as used herein is a soy material having a protein content of at least about 90% soy protein on a moisture free basis. A soy protein isolate is formed from soybeans by removing the hull and germ of the soybean from the cotyledon, flaking or grinding the cotyledon and removing oil from the flaked or ground cotyledon, separating the soy protein and soluble carbohydrates of the cotyledon from the cotyledon fiber, and subsequently separating the soy protein from the soluble carbohydrates.

The term “strand” as used herein refers to a plant protein product having a size of approximately 2.5 to about 4 centimeters in length and greater than approximately 0.2 centimeter in width after the shred characterization test detailed in Example 2 is performed.

The term “starch” as used herein refers to starches derived from any native source. Typically sources for starch are cereals, tubers, roots, and fruits.

The term “weight on a moisture free basis” as used herein refers to the weight of a material after it has been dried to completely remove all moisture, e.g. the moisture content of the material is 0%. Specifically, the weight on a moisture free basis of a material can be obtained by weighing the material after the material has been placed in a 45° C. oven until the material reaches a constant weight.

The term “wheat flour” as used herein refers to flour obtained from the milling of wheat. Generally speaking, the particle size of wheat flour is from about 14 to about 120 μm.

The following examples are included to demonstrate preferred embodiments of the invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the accompanying drawings is to be interpreted as illustrative and not in a limiting sense.

### EXAMPLES

The following examples illustrate the dried food compositions of the invention.

### Example 1

### Determination of Shear Strength of the Structured Protein Product

Shear strength of a sample is measured in grams and may be determined by the following procedure. Weigh a sample of the structured protein product and place it in a heat sealable pouch and hydrate the sample with approximately three times the sample weight of room temperature tap water. Evacuate the pouch to a pressure of about 0.01 Bar and seal the pouch. Permit the sample to hydrate for about 12 to about 24 hours. Remove the hydrated sample and place it on the texture analyzer base plate oriented so that a knife from the texture analyzer will cut through the diameter of the sample. Further, the sample should be oriented under the texture analyzer knife such that the knife cuts perpendicular to the long axis of the textured piece. A suitable knife used to cut the extrudate is a model TA-45, incisor blade manufactured by Texture Technologies (USA). A suitable texture analyzer to perform this test is a model TA, TXT2 manufactured by Stable Micro Systems Ltd. (England) equipped with a 25, 50, or 100 kilogram load. Within the context of this test, shear strength is the maximum force in grams needed to shear through the sample.

### Example 2

### Determination of Shred Characterization

A procedure for determining shred characterization may be performed as follows. Weigh about 150 grams of a structured protein product using whole pieces only. Place the sample into a heat-sealable plastic bag and add about 450 grams of water at 25° C. Vacuum seal the bag at about 150 mm Hg and allow the contents to hydrate for about 60 minutes. Place the hydrated sample in the bowl of a Kitchen Aid mixer model KM14G0 equipped with a single blade paddle and mix the contents at 130 rpm for two minutes. Scrape the paddle and the sides of the bowl, returning the scrapings to the bottom of the bowl. Repeat the mixing and scraping two times. Remove ˜200 g of the mixture from the bowl. Separate the ˜200 g of mixture into three groups. Group 1 is the portion of the sample having fibers at least 4 centimeters in length and at least 0.2 centimeters wide. Group 2 is the portion of the sample having strands between 2.5 cm and 4.0 cm long, and which are ≧0.2 cm wide. Group 3 is the portion that does not fit within the parameters of Group 1 and Group 2. Weigh Groups 1 and 2 together, and divide by the starting weight (e.g. ˜200 g). This determines the percentage of large pieces in the sample. If the resulting value is below 15%, or above 20%, the test is complete. If the value is between 15% and 20%, then weigh out another ˜200 g from the bowl, separate the mixture into the three groups, and perform the calculations again.

### Example 3

### Production of Structured Protein Products

The following extrusion process may be used to prepare the structured protein products of the invention. Added to a paddle blender are the following: 1000 kilograms (kg) Supro® 620 (soy isolate), 440 kg wheat gluten, 171 kg wheat starch, 34 kg soy cotyledon fiber, 10 kg of xylose, 9 kg dicalcium phosphate, and 1 kg L-cysteine. The contents are mixed to form a dry blended soy protein mixture. The dry blend is then transferred to a hopper from which the dry blend is introduced into a preconditioner along with water to form a conditioned soy protein pre-mixture. The conditioned soy protein pre-mixture is then fed to a twin-screw extrusion apparatus at a rate of not more than 75 kg/minute. The extrusion apparatus comprises five temperature control zones, with the protein mixture being controlled to a temperature of from about 25° C. in the first zone, about 50° C. in the second zone, about 95° C. in the third zone, about 130° C. in the fourth zone, and about 150° C. in the fifth zone. The extrusion mass is subjected to a pressure of at least about 400 psig in the first zone up to about 1500 psig in the fifth zone. Water is injected into the extruder barrel, via one or more injection jets in communication with a heating zone.

A die assembly is attached to the extruder in an arrangement that permits the plasticized mixture to flow from the extruder exit port into the die assembly and produces substantial alignment of the protein fibers within the plasticized mixture as it flows through the die assembly.

As the extrudate containing protein fibers that are substantially aligned exits the die assembly, it is cut with knives and the cut mass is then dried to a moisture content of about 10% by weight.

### Example 4

### Raw Restructured Meat Mix

The raw restructured meat mix was prepared according to the formula presented in Table 1. The structured protein product (SPP) was hydrated in 3 parts of water in a vacuum-sealed package. The hydrated SPP was placed in a mixer along with the caramel color, and the mixture was mixed until all pieces are shredded and fibrous. The shredded SPP, the meats, salt, and phosphates were vacuum mixed for 10 minutes. The remaining ingredients were added and were vacuum mixed for 5 minutes thereby forming the raw restructured meat mix.

TABLE 1
Formula for the raw restructured meat.

| | Amount |
|---|---|
| Ingredient | (%) |
| Chicken MDM (18% fat) | 45.00 |
| Beef lean (10% fat) | 2.00 |
| Beef fat (90% fat) | 3.00 |
| Salt | 1.15 |
| Sodium phosphates | 0.30 |
| Isolated soy protein | 6.00 |
| SPP | 10.00 |
| Water | 31.27 |
| Beef flavor & Seasonings | 1.00 |
| Caramel color | 0.28 |
| Total | 100.00 |

### Example 5

### Teriyaki Flavored Jerky Style Snacks

Teriyaki flavored jerky style meat snacks (FIG. 11) were prepared from restructured meat comprising structured protein products using a two-step method. First, the raw restructured meat mix was prepared, and second, the meat snack was made from the raw restructured meat mix. The raw restructured meat mix was made following the methods in Example 4 and ingredients in Table 1.

To make the teriyaki flavor jerky style snacks, the raw restructured meat mix of Example 4 was stuffed into fibrous casings (or placed in loaf pans) and cooked at 80° C. in the smokehouse without humidity for 30 minutes and then steamed to an internal temperature of 75° C. The resulting fully cooked restructured meat was chilled, sliced, and placed on a pan that had been coated with vegetable oil. The slices were dried in a 200° F. oven. The slices were then coated with the seasoning mix (see Table 2) and dried in a 300° F. oven until the yield was 50% (i.e., the total weight of the slices and seasonings were reduced to 50%). A jerky style snack was produced that had a water activity of 0.63.

TABLE 2
Formula for the Teriyaki Flavor Jerky style snack.

| | Amount |
|---|---|
| Ingredient | (%) |
| Restructured meat slices | 65.70 |
| Teriyaki sauce | 18.30 |
| Shiitake extract | 0.30 |
| Sugar | 13.10 |
| Ginger juice | 0.40 |
| Oil | 2.20 |
| Total | 100.00 |

### Example 6

### Pepper Flavored Jerky Style Snack

To make the pepper flavored jerky style snack, the raw restructured meat mix (as shown in the Example 4 and Table 1) was blended with the other ingredients in Table 3. After approximately 2 minutes blending, the final mix was extruded into strips approximately ¼ in×1 in×6 in (6 mm×25 mm×15 mm). The strips were dried on screens with Teflon mesh at 80° C. to a water activity of 0.86.

TABLE 3
Formula for the Pepper Flavored Jerky style snack.

| | Amount |
|---|---|
| Ingredient | (%) |
| Restructured meat mix (raw) | 90.58 |
| Sugar | 6.20 |
| Soy Sauce | 1.88 |
| Vinegar | 0.50 |
| Coarse Black Pepper | 0.50 |
| Paprika | 0.10 |
| Liquid Smoke | 0.10 |
| Spices | 0.14 |
| Total | 100.00 |

### Example 7

### Korean Bulgogi Flavored Rice Topping

A shelf-stable rice topping (FIG. 9) was also prepared with the restructured meat. The restructured meat was prepared as described in Example 4 and Table 1. The restructured meat was shredded and the shreds were sauteed in vegetable oil. The pre-blended sauce/seasoning mix (see Table 4) was added to the shreds, and the mixture was heated until the liquid was evaporated. The seasoned shreds were dried in a 300° F. oven until the yield was 60%. The water activity of the shelf stable rice topping was 0.70.

TABLE 4
Formula for Rice Topping.

| | Amount |
|---|---|
| Ingredient | (%) |
| Restructured meat, shredded | 63.80 |
| Bulgogi sauce | 26.40 |
| Sugar | 7.40 |
| Shiitake extract | 0.20 |
| Vegetable oil | 2.20 |
| Total | 100.00 |

### Example 8

### Rice Topping and Meat Snacks Made Using a Modified Method

For this method, the seasonings and flavors for the snacks (FIG. 10) and rice topping were incorporated in the formula to make the restructured meat (see Table 5).

TABLE 5
Formula.

| Step | Ingredient | G | % |
|---|---|---|---|
| 1 | SPP | 57.10 | 8.50 |
| | Water | 142.90 | 21.30 |
| 2 | Calcium Chloride | 2.00 | 0.30 |
| | dihydrate | | |
| | Water | 30.00 | 4.50 |
| 3 | Beef inside (⅛″) | 150.00 | 22.40 |
| | Beef fat (⅛″) | 15.00 | 2.20 |
| | Water | 100.00 | 14.90 |
| | Isolated soy protein | 20.00 | 3.00 |
| | Sodium phosphates | 1.00 | 0.10 |
| | Salt | 1.50 | 0.20 |
| | Sugar | 30.00 | 4.50 |
| | Shiitake extract | 0.50 | 0.10 |
| | Bulgogi sauce | 100.00 | 14.90 |
| | Oil | 15.00 | 2.20 |
| | Beef flavor | 2.50 | 0.40 |
| | Caramel color | 2.20 | 0.30 |
| | Total | 669.70 | 100.00 |

The SPP was hydrated in 2.5 parts of water (step 1). A calcium chloride solution was made by mixing the calcium chloride dihydrate and water (step 2). The beef lean was chopped with the salt and the sodium phosphates in a food processor. The fat was added and chopped (the chopped meats were kept cold until used, see below). The hydrated SPP was shredded in a mixer, and the calcium chloride solution was added and mixed. The caramel color was added to the SPP/calcium chloride mixture and mixed. The remaining seasoning ingredients were added with the SPP mixture and mixed. The chopped meat and fat mixture (from above) was added to the SPP mixture and thoroughly blended. The mixture was shaped and cooked to 80° C. The cooked product was cut into cubes, strips, and shreds. The products were then further dried to reduce the water activity to below 0.85. The products were then vacuum packed.

The jerky style snacks gave a yield of 44.2% and had a water activity of 0.72. The rice topping had a yield of 50.4% and a water activity of 0.76.

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A dried food composition, the composition comprising:
a. structured plant protein product, the product having protein fibers that are substantially aligned; and,
b. a firming agent.

2. The dried food composition of claim 1, wherein the firming agent is a non-acid firming agent, wherein the non-acid firming agent is selected from the group consisting of calcium chloride, calcium sulfate, natural nigari, magnesium chloride, magnesium sulphate, calcium hydrogen sulphite, monocalcium citrate, dicalcium citrate, tricalcium citrate, monocalcium phosphate, dicalcium phosphate, tricalcium phosphate, calcium gluconate, and combinations thereof.

3. The dried food composition of claim 1, wherein the structured protein product has an average shear strength of at least 1400 grams and an average shred characterization of at least 10%.

4. The dried food composition of claim 1, wherein the structured protein product comprises protein fibers substantially aligned in the manner depicted in the micrographic image of FIG. 1.

5. The dried food composition of claim 1, further comprising animal meat, wherein the animal meat is selected from the group consisting of pork, beef, lamb, poultry, wild game, fish, shellfish, and combinations thereof.

6. The dried food composition of claim 5, wherein the composition comprises from about 40% to about 60% by weight of the structured protein product, and from about 40% to about 60% by weight animal meat.

7. The dried food composition of claim 1, wherein the structured protein product is extruded through a die assembly resulting in a structured protein product having protein fibers that are substantially aligned.

8. The dried food composition of claim 1, wherein the structured protein product comprises soy protein, soy protein isolate, soy protein concentrate, starch, gluten, fiber, and mixtures thereof.

9. The dried food composition of claim 9, wherein the structured protein product comprises,
a. from about 45% to about 65% soy protein on a dry matter basis;
b. from about 20% to about 30% wheat gluten on a dry matter basis;
c. from about 10% to about 15% wheat starch on a dry matter basis; and,
d. from about 1% to about 5% fiber on a dry matter basis.

10. The dried food composition of claim 1, comprising a fat substance wherein the fat substance is selected form the group consisting of:
a. a dairy based fat wherein the dairy based fat selected from the group consisting of butter, cheese, cream, and combinations thereof;
b. a vegetable based fat, wherein the vegetable based fat is selected from the group consisting of a hydrogenated, partially hydrogenated vegetable oil, palm oil, coconut oil, cottonseed oil, canola oil, sunflower oil, safflower oil, soybean oil, peanut oil, flax seed oil, grape seed oil, olive oil, corn oil, rice oil, and mixtures thereof;
c. an animal based fat, wherein the animal based fat is selected from the group consisting of tallow, lard, chicken fat, fish oil, and mixtures thereof.

11. The dried food composition of claim 1, comprising a pH-adjusting agent, wherein the pH-adjusting agent is an acid selected from the group consisting of acetic, lactic, hydrochloric, gluconic, phosphoric, citric, tartaric, malic, sodium acid pyrophosphate, and mixtures thereof.

12. The dried food composition of claim 1, comprising a colorant, wherein the food colorant is selected from a lake, a natural dye, an artificial dye, and combinations thereof.

13. The dried food composition of claim 1, comprising a vitamin and mineral mixture in an amount from about 1.0% to about 10.0% by weight.

14. The dried food composition of claim 1, comprising a fatty acid, wherein the fatty acid is selected from the group consisting of polyunsaturated fatty acid, omega-3 fatty acid, omega-6 fatty acid, omega-9 fatty acid, and mixtures thereof.

15. The dried food composition of claim 1, comprising a flavoring agent, wherein the flavoring agent is selected from the group consisting of animal meat flavor, animal meat oil, spice extracts, spice oils, natural smoke solutions, natural smoke extracts, yeast extracts, onion flavor, garlic flavor, herb flavor, and flavor enhancers including sodium chloride, potassium chloride, monosodium glutamate, nucleotides, hydrolyzed vegetable protein, shiitake mushroom extract, kelp seaweed extract, fermentation sauces, and mixtures thereof.

16. The dried food composition of claim 1, comprising a humectant, wherein the humectant is selected from the group consisting of sucrose, dextrose, fructose, maltose, xylose, maple syrup, corn syrup, honey, molasses, erythritol, hydrogenated starch hydrosylates, isomalt, lacitiol, maltitol, mannitol, sorbitol, xylitol, glycerine, propylene glycol, triacetin, potassium lactate, sodium lactate, and combinations thereof.

17. The dried food composition of claim 1, comprising an antioxidant, wherein the antioxidant is selected from the group consisting of ascorbic acid, N-acetylcysteine, benzyl isothiocyanate, beta-carotene, chlorogenic acid, citric acid, 2,6-di-tert-butylphenol, lactic acid, tartaric acid, uric acid, rosemary extract, tocopherols (vitamin E), vitamin K, and combinations thereof.

18. The dried food composition of claim 1, comprising a preservative, wherein the preservative is selected from the group consisting of sorbic acid, potassium sorbate, benzoates, butylated hydroxytoluene, butylated hydroxyanisole, tert-butylhydroquinone, propylgallate, antioxidants, citric acid, ascorbic acid, EDTA (ethylenediamine tetra-acetic acid), nitrites, nitrates, propionates, sulfites, sulfur dioxide, and combinations thereof.

19. The dried food composition of claim 1, wherein the dried food composition is selected from the group consisting of a food topping, a jerky style meat snack, a shredded meat product, and combinations thereof.

20. The dried food composition of claim 1, wherein the dried food composition has a water activity of from about 0.5 to about 0.95.

21. A vegetarian dried food composition, the composition comprising:
a. a structured plant protein product, wherein the structured protein product comprises from about 45% to about 65% soy protein on a dry matter basis, from about 20% to about 30% wheat gluten on a dry matter basis; from about 10% to about 15% wheat starch on a dry matter basis; and from about 1% to about 5% fiber on a dry matter basis; and,
b. a firming agent.

22. The dried food composition of claim 21, wherein the structured protein product comprises protein fibers substantially aligned in the manner depicted in the micrographic image of FIG. 1.
